(19) United States
(12) Patent Application Publication
(10) Pub. No.: US 2004/0109114 A1
(43) Pub. Date: Jun. 10, 2004

(54) Retarder and circular polarizer

(75) Inventors: Hiroshi Takeuchi, Minami-ashigara-shi (JP); Tadashi Ito, Minami-ashigara-shi (JP)

Correspondence Address: BURNS DOANE SWECKER & MATHIS L L P, POST OFFICE BOX 1404, ALEXANDRIA, VA, 22313-1404, US

(73) Assignee: Fuji Photo Film Co., Ltd.

(21) Appl. No.: 10/634,906

(22) Filed: Aug. 6, 2003

(30) Foreign Application Priority Data
Aug. 7, 2002 (JP) 2002-229921

(51) Int. Cl. G02F 1/1335

(52) U.S. Cl. 349/117

(57) ABSTRACT

A retarder comprising a substrate having a longitudinal direction and a first and second optically anisotropic layers respectively formed of a composition comprising a rod-like liquid-crystalline compound, in which the rod-like molecules are aligned homogeneously. The first layer substantially generates a phase difference of π at 550 nm, and the second layer substantially generates a phase difference of π/2 at 550 nm. An in-plane slow axis of the first layer and the longitudinal direction cross substantially at +30 degrees, an in-plane slow axis of the second layer and the longitudinal direction cross substantially at −30 degrees, and the slow axis of the second layer and the slow axis of the first layer cross substantially at 60 degrees. A circular polarizer comprising the retarder and a linear polarizer film having a transparent axis inclined at 45 degrees relative to the longitudinal direction is also disclosed.

### FIELD OF THE INVENTION

The present invention relates to a retarder comprising two optically anisotropic layers useful as a quarter wave plate used for reflective-type liquid crystal display devices, write pickups for optical disks, or anti-reflective films. In particular, the present invention relates to a retarder comprising two optically anisotropic layers which can be respectively prepared by applying a composition comprising a rod-like liquid-crystalline compound on or above a surface of a substrate, and a circular polarizer which can be prepared by lamination of the retarder and a linear polarizing film in a roll-to-roll manner.

### RELATED ART

Quarter wave plates can be used for various purposes and have already been practically used. However, most of quarter wave plates achieve λ/4 only at a specific wavelength though they are called quarter wave plates. JPA No. 1998-68816 and JPA No. 1998-90521 (the term “JPA” as used herein means an “unexamined published Japanese patent application”) disclose retarders obtained by laminating two optically anisotropic polymer films. In the retarder described in JPA No. 1998-68816, a quarter-wave plate generating a quarter wavelength phase difference and a half-wave plate generating a half wavelength phase difference are laminated so that their optic axes are crossed. In the retarder described in JPA No. 1998-90521, at least two retarders having a retardation value of 160-320 nm are laminated at an angle such that their slow axes are neither parallel nor orthogonal to each other. The retarders described in both documents specifically having laminate structures of two polymer films. Both documents explain that λ/4 can be achieved in a wide wavelength region by such retarders. However, the preparation processes of the retarders described in JPA No. 1998-68816 and JPA No. 1998-90521 require cutting two polymer films at a predetermined angle and laminating the resulting chips in order to control the optical directions (optic axes or slow axes) of the two polymer films. Such processes including laminating the resulting chips are complex and have other disadvantages such as liability to quality failure due to misalignment, decrease in yield, increase in cost and liability to deterioration due to contamination. Moreover, it is difficult to strictly adjust the retardation value of polymer films to a desired value.

On the other hand, a broadband quarter wave plate comprising at least two optically anisotropic layers respectively formed of a liquid-crystalline compound are disclosed in JPA No. 2001-4837, JPA No. 2001-21720 and JPA No. 2000-206331. Especially, the technique disclosed in JPA No. 2001-4837, in which the same liquid crystal compounds can be used in the optically anisotropic layers, is also attractive in terms of production costs.

In order to prepare a long circular polarizer continuously, it is necessary to laminate a half-wave plate on a linear polarizer so as to cross an optical axis of the half-wave plate and a transparent axis of the linear polarizer at a predetermined angle. For preparation of a circular polarizer according to the process described in JPA No. 2001-4837, a rubbing treatment in a direction at 75 degrees relative to a longitudinal direction is required, however, in fact, it is difficult to perform such a rubbing treatment.

### SUMMARY OF THE INVENTION

One object of the present invention is to provide retarders capable of functioning in a broad band, that is, in the visible light wave length region, of contributing to thinning, and of being prepared stably and readily. Another object of the present invention is to provide circular polarizers capable of functioning in a broad band, that is, in the visible light wave length region, of contributing to thinning, and of being prepared stably and easily. Another object of the present invention is to provide processes for easily and stably preparing retarders and circular polarizers capable functioning in a broad band, that is, in the visible light wave length region.

In one aspect, the present inventions provides a retarder comprising:

a substrate having a longitudinal direction,

a first optically anisotropic layer formed of a composition comprising a rod-like liquid-crystalline compound, in which the rod-like molecules are aligned homogeneously, and substantially generating a phase difference of π at 550 nm, and

a second optically anisotropic layer formed of a composition comprising a rod-like liquid-crystalline compound, in which the rod-like molecules are aligned homogeneously, and substantially generating a phase difference of π/2 at 550 nm;

wherein an in-plane slow axis of the first optically anisotropic layer and the longitudinal direction of the substrate cross substantially at +30 degrees, an in-plane slow axis of the second optically anisotropic layer and the longitudinal direction of the substrate cross substantially at −30 degrees, and the in-plane slow axis of the second optically anisotropic layer and the in-plane slow axis of the first optically anisotropic layer cross substantially at 60 degrees.

As embodiments of the present invention, there are provided the retarder wherein a rubbing axis of an alignment layer for predetermining an orientation angle of the rod-like molecules in the first optically anisotropic layer and the longitudinal direction of the substrate cross substantially at +30 degrees, and a rubbing axis of an alignment layer for predetermining an orientation angle of the rod-like molecules in the second optically anisotropic layer and the longitudinal direction of the substrate cross substantially at −30 degrees; and the retader wherein at least one of the first and second optically anisotropic layers is formed of a composition comprising a rod-like liquid-crystalline compound denoted by Formula (I) bellow:

Q¹—L¹—Cy¹—L²—(Cy²—L³)ₙ—Cy³—L⁴—Q² Formula (I)

where Q¹ and Q² respectively denote a polymerizable group; L¹ and L⁴ respectively denote a divalent linking group, L² and L³ respectively denote a single bond or divalent linking group; Cy¹, Cy², and Cy³ respectively denote a divalent cyclic group; and n is 0, 1 or 2.

In another aspect, the present invention provides a process for preparing a retarder comprising:

(i) a step of preparing a layer on or above a surface of a substrate having a longitudinal direction and rubbing a surface of the layer in a direction at +30 degrees relative to the longitudinal direction of the substrate, to prepare a first alignment layer capable of aligning rod-like liquid-crystalline molecules in a direction parallel to a rubbing axis,

(ii) a step of applying a composition comprising a rod-like liquid-crystalline compound to the rubbed surface of the first alignment layer and aligning rod-like molecules homogenously in a direction parallel to the rubbing axis of the first alignment layer, to prepare a first optically anisotropic layer generating substantially a phase difference of π at 550 nm,

(iii-1) a step of preparing a layer on or above the surface of the substrate and rubbing a surface of the layer in a direction at −30 degrees relative to the longitudinal direction of the substrate, namely, in a direction crossing the rubbing axis of the first alignment layer at 60 degrees, to prepare a second alignment layer capable of aligning rod-like liquid-crystalline molecules in a direction parallel to a rubbing axis, or

(iii-2) a step of preparing a layer on or above a rear surface of the substrate and rubbing a surface of the layer in a direction at +30 degrees relative to the longitudinal direction of the substrate, namely, in a direction crossing the rubbing axis of the first alignment layer at 60 degrees, to prepare a second alignment layer capable of aligning rod-like liquid-crystalline molecules in a direction parallel to a rubbing axis, and

(iv) a step of applying a composition comprising a rod-like liquid-crystalline compound to the rubbed surface of the second alignment layer and aligning rod-like molecules homogenously in a direction parallel to the rubbing axis of the second alignment layer, to prepare a second optically anisotropic layer generating substantially a phase difference of π/2 at 550 nm.

As embodiments of the present invention, there is provided the process wherein at least one of the rod-like liquid-crystalline compounds used in the first and second optically anisotropic layers is denoted by the above-mentioned Formula (I).

In another aspect, the present invention provides a circular polarizer comprising:

a linear polarizer film having a transparent axis substantially inclined at +45 degrees or −45 degrees relative to a longitudinal direction thereof,

a substrate having a longitudinal direction,

a first optically anisotropic layer formed of a composition comprising a rod-like liquid-crystalline compound, in which the rod-like molecules are aligned homogeneously, and substantially generating a phase difference of π at 550 nm, and

a second optically anisotropic layer formed of a composition comprising a rod-like liquid-crystalline compound, in which the rod-like molecules are aligned homogeneously, and substantially generating a phase difference of π/2 at 550 nm;

wherein an in-plane slow axis of the first optically anisotropic layer and the longitudinal direction of the substrate cross substantially at +30 degrees, an in-plane slow axis of the second optically anisotropic layer and the longitudinal direction of the substrate cross substantially at −30 degrees, and the in-plane slow axis of the second optically anisotropic layer and the in-plane slow axis of the first optically anisotropic layer cross substantially at 60 degrees.

As the embodiments of the present invention, there are provided the circular polarizer wherein a rubbing axis of an alignment layer for predetermining an orientation angle of the rod-like molecules in the first optically anisotropic layer and the longitudinal direction of the substrate cross substantially at +30 degrees, and a rubbing axis of an alignment layer for predetermining an orientation angle of the rod-like molecules in the second optically anisotropic layer and the longitudinal direction of the substrate cross substantially at −30 degrees; and the circular polarizer wherein at least one of the first and second optically anisotropic layers is formed of a composition comprising a rod-like compound denoted by the above-mentioned Formula (I).

In another aspect, the present invention provides a process for preparing a circular polarizer comprising:

(i) a step of preparing a layer on or above a surface of a substrate having a longitudinal direction and rubbing a surface of the layer in a direction at +30 degrees relative to the longitudinal direction of the substrate, to prepare a first alignment layer capable of aligning rod-like liquid-crystalline molecules in a direction parallel to a rubbing axis,

(ii) a step of applying a composition comprising a rod-like liquid-crystalline compound to the rubbed surface of the first alignment layer and aligning rod-like molecules homogenously in a direction parallel to the rubbing axis of the first alignment layer, to prepare a first optically anisotropic layer generating substantially a phase difference of π at 550 nm,

(iii-1) a step of preparing a layer on or above the surface of the substrate and rubbing a surface of the layer in a direction at −30 degrees relative to the longitudinal direction of the substrate, namely, in a direction crossing the rubbing axis of the first alignment layer at 60 degrees, to prepare a second alignment layer capable of aligning rod-like liquid-crystalline molecules in a direction parallel to a rubbing axis, or

(iii-2) a step of preparing a layer on or above a rear surface of the substrate and rubbing a surface of the layer in a direction at +30 degrees relative to the longitudinal direction of the substrate, namely, in a direction crossing the rubbing axis of the first alignment layer at 60 degrees, to prepare a second alignment layer capable of aligning rod-like liquid-crystalline molecules in a direction parallel to a rubbing axis,

(iv) a step of applying a composition comprising a rod-like liquid-crystalline compound to the rubbed surface of the second alignment layer and aligning rod-like molecules homogenously in a direction parallel to the rubbing axis of the second alignment layer, to prepare a second optically anisotropic layer generating substantially a phase difference of π/2 at 550 nm, and

(v) a step of laminating a linear polarizer film, having a transparent axis substantially inclined at +45 degrees or −45 degrees relative to a longitudinal direction thereof, on or above the surface or the rear surface of the substrate, so that the longitudinal directions of the linear polarizer film and of the substrate are identical.

As embodiments of the present invention, there are provided the process wherein the first and second optically anisotropic layers are prepared on or above the surface of the substrate and the linear polarizer film is laminated on or above the surface of the substrate; the process wherein the first and second optically anisotropic layers are prepared on or above the surface of the substrate and the linear polarizer film is laminated on or above the rear surface of the substrate; and the process wherein at least one of the rod-like liquid-crystalline compounds used in the first and second optically anisotropic layers is denoted by the above-mentioned Formula (I).

In the present specification, the term of “substantially” for an angle means that the angle is in the range of an exact angle ±5°. Preferably, the difference from the exact angle is less than 4°, and more preferably less than 3°. In the present specification, signs of “+” and “−” for the angle do not limit the rightward direction and leftward direction respectively, and are used for only relatively expressing angles in directions differing with each other. In the present specification, “a slow axis” means a direction showing a maximum refractive index.

### BRIEF DESCRIPTION OF THE DRAWINGS

FIGS. 1 to 4 are schematic drawings of exemplary retarders of the present invention.

FIGS. 5 to 9 are schematic drawings of exemplary circular polarizers of the present invention.

FIG. 10 is a schematic sectional view showing an exemplary layer constitution of the circular polarizer plate of the present invention.

FIG. 11 is a schematic sectional view showing another exemplary layer constitution of the circular polarizer plate of the present invention.

FIG. 12 is a schematic sectional view showing an exemplary layer constitution of the circular polarizer plate fabricated in Example 2 or 3.

### DETAILED DESCRIPTION OF THE INVENTION

[Optical Characteristics of Retarder]

The retarder of the present invention comprises a first optically anisotropic layer formed of a composition comprising a rod-like liquid-crystalline compound, in which the rod-like molecules are aligned homogeneously; and a second optically anisotropic layer formed of a composition comprising a rod-like liquid-crystalline compound, in which the rod-like molecules are aligned homogeneously. The first optically anisotropic layer generates a phase difference of π substantially at a specific wavelength, and the second optically anisotropic layer generates a phase difference of π/2 substantially at the wavelength. In order to obtain a π phase difference at a wavelength (λ) through an optically anisotropic layer, it is necessary to prepare the layer so as to adjust the measured retardation of the layer to λ/2 at the λ. In order to obtain a π/2 phase difference at a wavelength (λ) through an optically anisotropic layer, it is necessary to prepare the layer so as to adjust the measured retardation of the layer to λ/4 at the λ. It is preferable that the optically anisotropic layers can generate π and π/2 phase differences respectively at 550 nm, which is mostly the middle of visible light range. That is, the first optically anisotropic layer desirably has a retardation in the range from 200 to 350 nm, preferably from 240 to 300 nm, at 550 nm. The second optically anisotropic layer desirably has a retardation in the range from 100 to 180 nm, preferably from 120 to 150 nm, at 550 nm.

In the specification, a retardation (Re) of an anisotropic layer means an in-pale retardation when light incident along the normal line direction of the layer. Specifically, a retardation is the value defined by the following formula:

Re=(nx−ny)×d

In the formula, nx and ny denote the in-plane major refractive indexes of the optically anisotropic layer, and d (nm) denotes the thickness of the layer.

The thickness of the first and second optically anisotropic layers can arbitrarily be determined within a range in which the individual layers can exhibit desired retardation values. Although preferable ranges for the thickness of the individual optically anisotropic layers may differ depending on the rod-like liquid-crystalline compounds to be used, it is preferably 0.3 to 20 micro meters in general, more preferably 0.4 to 15 micro meters, and still more preferably 0.6 to 10 micro meters. According to the present invention, the retarder is successfully thinned by forming the individual optically anisotropic layers so as to align homogeneously the liquid-crystalline molecules contained therein.

It is to be noted now that the term of “homogeneous alignment” in the context of the present specification is used for not only homogeneous alignment in an absolute sense but also for any alignments inclined at a tilt angle of 10 degrees or around.

[Constitutions of Retarder and Circular Polarizer Plate]

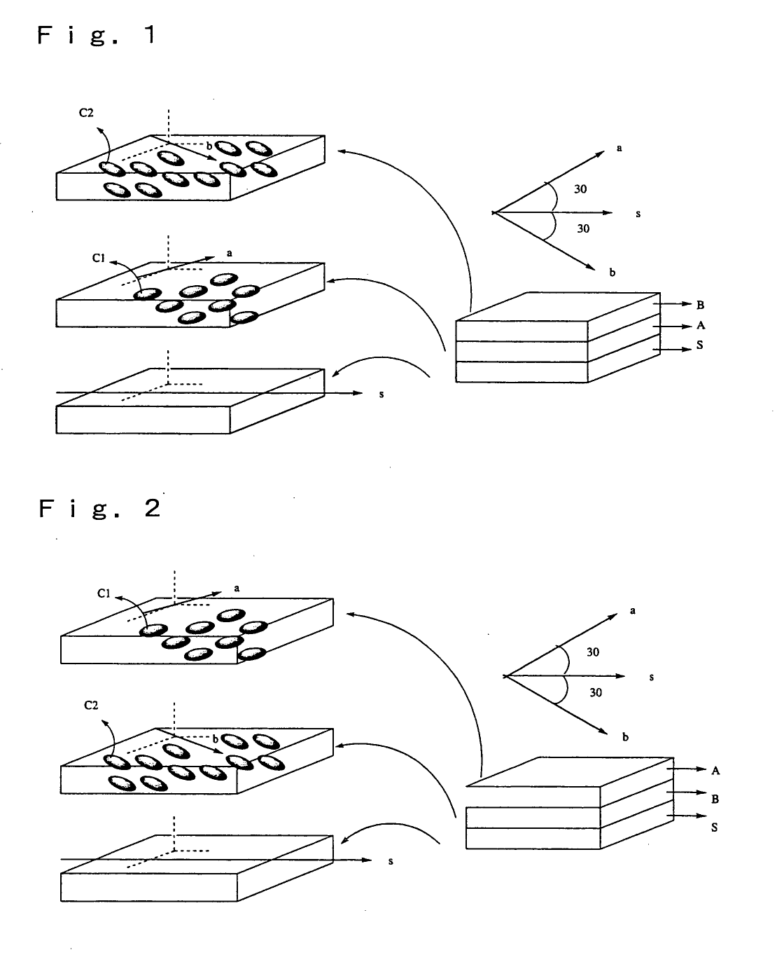

FIGS. 1 to 4 are schematic drawings of exemplary retarders of the present invention. As shown respectively in FIGS. 1 to 4, the basic retarder of the present invention comprises a long transparent substrate (S) and the first optically anisotropic layer (A), and further comprises the second optically anisotropic layer (B). The first optically anisotropic layer (A) generates a phase difference of π. The second optically anisotropic layer (B) generates a phase difference of π/2. The longitudinal direction of the transparent substrate (S) and the slow axis (a) of the first optically anisotropic layer (A) cross at 30 degrees. The slow axis (b) of the second optically anisotropic layer (B) and the slow axis (a) of the first optically anisotropic layer (A) cross at an angle (γ) of 60 degrees. Both of the first and second optically anisotropic layers (A) and (B) shown in FIG. 1 respectively contain rod-like liquid-crystalline molecules (c1 and c2). The rod-like liquid-crystalline molecules c1 and c2 are aligned homogeneously. The longitudinal axes of the rod-like, liquid-crystalline molecules (c1 and c2) correspond to the slow axes (a and b) of the optically anisotropic layers.

The embodiment shown in FIG. 1 comprises a transparent substrate (S), a first optically anisotropic layer (A) on the substrate (S) and a second optically anisotropic layer (B) on the layer (A).

The embodiment shown in FIG. 2 comprises a transparent substrate (S), a second optically anisotropic layer (B) on the substrate (S) and a first optically anisotropic layer (A) on the layer (B).

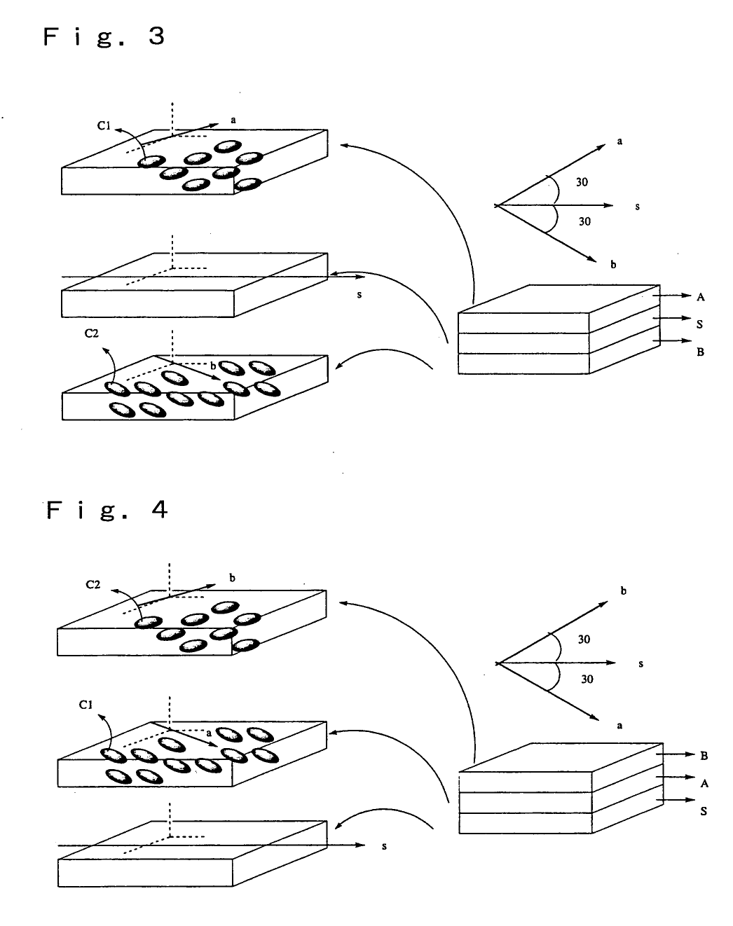

The embodiment shown in FIG. 3 comprises a transparent substrate (S), a first optically anisotropic layer (A) on one surface of the substrate (s) and a second optically anisotropic layer (B) on the other surface of the substrate (S).

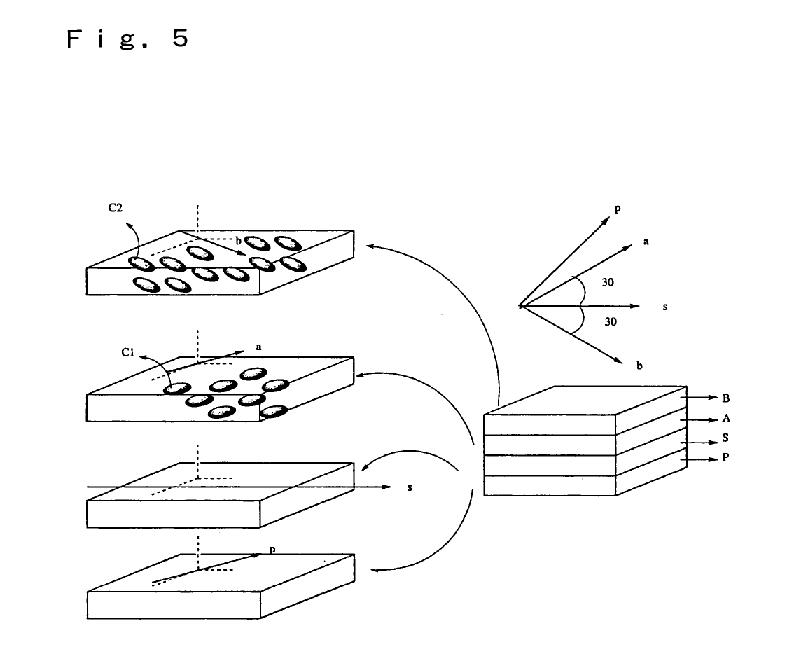

The embodiment shown in FIG. 4 has a same layer constitution as that shown in FIG. 1, except that the slow axes of the first and second optically anisotropic layers are exchanged, that is, in FIG. 4 the slow axis (b) of the layer (B) is +30 degrees relative to the longitudinal direction (s), which is identical to the slow axis (a) of the layer (A) in FIG. 1, and the slow axis (a) of the layer (A) is −30 degrees relative to the longitudinal direction (s), which is identical to the slow axis (b) of the layer (B) in FIG. 1.

The embodiments of the present invention include the retarders which have a same layer constitution as those shown in FIGS. 1 to 4 except that the slow axes of (a) and (b) are exchanged. According to the present invention, the retaerder shown in FIG. 1, comprising a transparent substrate (s) and an optically anisotropic layer (A) generating a phase difference of π on the substrate (S) and an optically anisotropic layer (B) generating a phase difference of π/2 on the layer (A) is desirable.

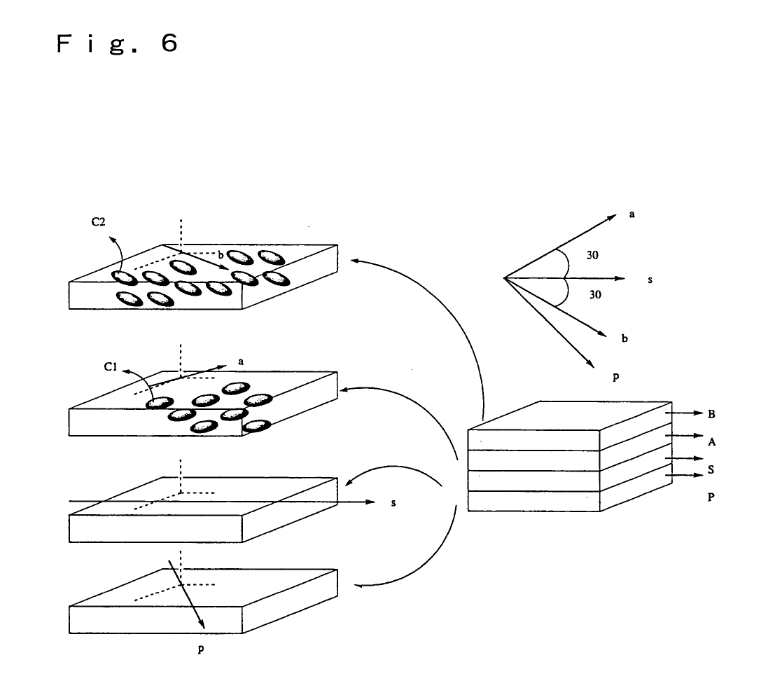

FIGS. 5 to 9 are schematic drawings showing a representative constitution of the circular polarizer of the present invention. The circular polarizers shown respectively in FIGS. 4 to 9 comprise the transparent substrate (S), the first and second optically anisotropic layers (A) and (B) as same as shown respectively in FIGS. 1 to 4, and further comprise a linear polarizer film (P). The transparent axis (p) of the linear polarizer film (P) and the longitudinal direction (s) of the transparent substrate (S) cross at 45 degrees, and similar to as illustrated in FIGS. 1 to 4, the slow axis (a) of the first optically anisotropic layer (A) and the slow axis (b) of the second optically anisotropic layer (B) cross at 60 degrees. The first optically anisotropic layers (A) and the second optically anisotropic layers (B) shown in FIGS. 5 to 9 respectively contain the rod-like liquid-crystalline molecules (c1 and c2). The rod-like liquid-crystalline molecules (c1 and c2) are aligned homogeneously. The longitudinal axes of the rod-like liquid-crystalline molecules (c1 and c2) correspond to the in-plane slow axes (a and b) of the optically anisotropic layers (A and B).

The embodiment shown in FIG. 5, comprises a retarder shown in FIG. 1 and a linear polarizer film, in which the transparent axis (s) of the polarizer and the slow axis (a) of the layer (A) cross at 15 degrees, and the transparent axis (s) of the polarizer and the slow axis (b) of the layer (B) cross at 75 degrees. The embodiment shown in FIG. 5 is a right circular polarizer, that is, linear light can be changed to right circular polarized light by passing through the circular polarizer shown in FIG. 5.

The embodiment shown in FIG. 6, comprises a retarder shown in FIG. 1 and a linear polarizer film, in which the transparent axis (s) of the polarizer and the slow axis (a) of the layer (A) cross at 75 degrees, and the transparent axis (s) of the polarizer and the slow axis (b) of the layer (B) cross at 15 degrees. The embodiment shown in FIG. 6 is a left circular polarizer, that is, linear light is changed to left circular polarized light by passing through the circular polarizer shown in FIG. 6.

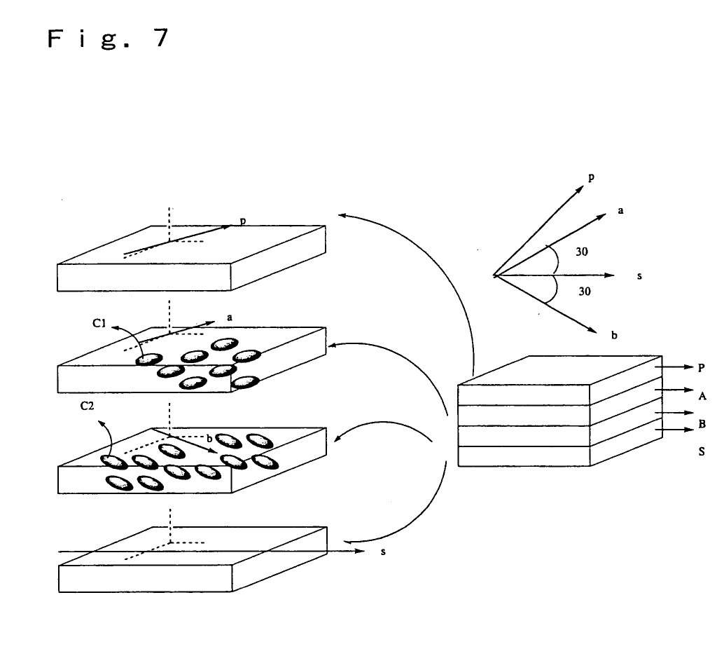

The embodiment shown in FIG. 7 comprises a retarder shown in FIG. 2 and a linear polarizer film, in which the transparent axis (s) of the polarizer and the slow axis (a) of the layer (A) cross at 15 degrees, and the transparent axis (s) of the polarizer and the slow axis (b) of the layer (B) cross at 75 degrees. The embodiment shown in FIG. 7 is a right circular polarizer, that is, linear light can be changed to right circular polarized light by passing through the circular polarizer shown in FIG. 7.

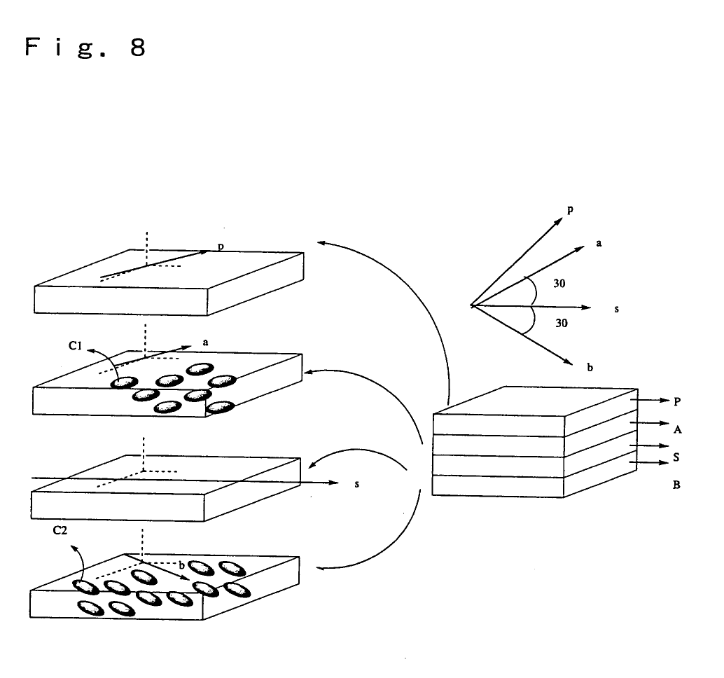

The embodiment shown in FIG. 8 comprises a retarder shown in FIG. 3 and a linear polarizer film, in which the transparent axis (s) of the polarizer and the slow axis (a) of the layer (A) cross at 15 degrees, and the transparent axis (s) of the polarizer and the slow axis (b) of the layer (B) cross at 75 degrees. The embodiment shown in FIG. 8 is a right circular polarizer, that is, linear light can be changed to right circular polarized light by passing through the circular polarizer shown in FIG. 8.

The embodiment shown in FIG. 9 comprises a retarder shown in FIG. 4 and a linear polarizer film, in which the transparent axis (s) of the polarizer and the slow axis (a) of the layer (A) cross at 75 degrees, and the transparent axis (s) of the polarizer and the slow axis (b) of the layer (B) cross at 15 degrees. The embodiment shown in FIG. 9 is a right circular polarizer, that is, linear light can be changed to right circular polarized light by passing through the circular polarizer shown in FIG. 9.

[Optically Anisotropic Layer]

According to the present invention, the retarder and circular polarizer plate comprise a first and second optically anisotropic layers respectively formed of a composition comprising a rod-like liquid-crystalline compound, in which the rod-like molecules are aligned homogenously. The liquid-crystalline compounds used in the first and second optically anisotropic layers may be identical or different each other. In the optically anisotropic layers, the rod-like molecules are desirably aligned in a substantially uniformly manner, more desirably fixed in a substantially uniformly aligned manner, and most preferably fixed by polymerization reaction. According to the present invention, the rod-like molecules in the optically anisotropic layers are desirably aligned in a manner such as an angle between the in-plane slow axis of the each optically anisotropic layer and the longitudinal direction of the transparent substrate is substantially +30 degrees or −30 degrees. The rod-like molecules in the optically anisotropic layers are desirably aligned homogeneously. The examples of the rod-like liquid-crystalline compounds include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyl dioxanes and alkenylcyclohexyl benzonitriles. Not only low-molecular-weight liquid-crystalline compounds as mentioned above but also high-molecular-weight liquid-crystalline compounds can be used. The rod-like liquid-crystalline molecules may be fixed in an alignment state by polymerization. The examples of the polymerizable rod-like liquid-crystalline compound include those described in “Makromol. Chem., Vol. 190, p. 2255(1989)”; “Advanced Materials Vol. 5, p. 107 (1993)”; U.S. Pat. Nos. 4,683,327, 5,622,648 and 5,770,107; International Publications WO95/22,586, WO95/24,455, WO97/00,600, WO98/23,580 and WO98/52905; JPA No. 1989-272551, JPA No. 1994-16616, JPA No.1995-110469 and JPA No. 1999-80081; and Japanese Patent Application No. 2001-64627.

The rod-like liquid-crystalline compounds denoted by the Formula (I) is desirably used.

Q¹—L¹—Cy¹—L²—(Cy²—L³)ₙ—Cy³—L⁴—Q² Formula (I)

In the Formula (I), Q¹ and Q² respectively denote a polymerizable group; L¹ and L⁴ respectively denote a divalent linking group; L² and L³ respectively denote a single bond or divalent linking group; Cy¹, Cy² and Cy³ respectively denote a divalent cyclic group; and n is 0, 1 or 2.

The polymerizable rod-like liquid-crystalline compound denoted by the formula (I) will be described in detail.

In the formula (I), Q¹ and Q² respectively denote a polymerizable group. The polymerizable group may be addition polymerizable (ring opening polymerizable) or condensation polymerizable. Preferably, Q¹ and Q² respectively denote a group capable of addition polymerization or condensation polymerization. The examples of the polymerizable groups are shown bellow.

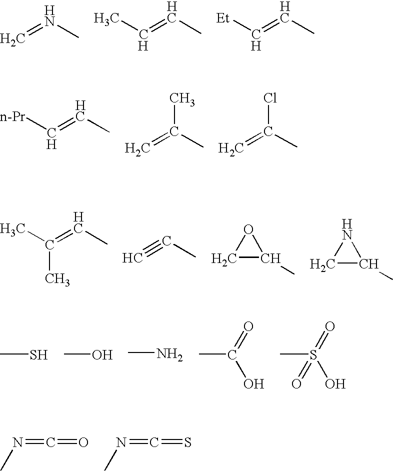

L¹ and L⁴ respectively denote a divalent liking group. Preferably, L¹ and L⁴ respectively denote a group selected from the group consisting of —O—, —S—, —CO—, —NR²—, a divalent chain group, divalent cyclic group and any combinations thereof. R² is a C1-7 alkyl group or hydrogen atom, desirably a C1-4 alkyl group or hydrogen atom and preferably methyl, ethyl or hydrogen atom and more preferably hydrogen atom. The examples of the combination linking groups are shown bellow. In the following examples, the left end of an exemplified group is bonded to Q¹ or Q² and the right end is bonded to Cy¹ or Cy³.

L-1: —CO—O—{a divalent chain group}—O—

L-2: —CO—O—{a divalent chain group}—O—CO—

L-3: —CO—O—{a divalent chain group}—O—CO—O—

L-4: —CO—O—{a divalent chain group}—O—{a divalent cyclic group}—

L-5: —CO—O—{a divalent chain group}—O—{a divalent cyclic group}—CO—O—

L-6: —CO—O—{a divalent chain group}—O—{a divalent cyclic group}—O—CO—

L-7: —CO—O—{a divalent chain group}—O—{a divalent cyclic group}—{a divalent chain group}—

L-8: —CO—O—{a divalent chain group}—O—{a divalent cyclic group}—{a divalent chain group}—CO—O—

L-9: —CO—O—{a divalent chain group}—O—{a divalent cyclic group}—{a divalent chain group}—O—CO—

L-10: —CO—O—{a divalent chain group}—O—CO—{a divalent cyclic group}—

L-11: —CO—O—{a divalent chain group}—O—CO—{a divalent cyclic group}—CO—O—

L-12: —CO—O—{a divalent chain group}—O—CO—{a divalent cyclic group}—O—CO—

L-13: —CO—O—{a divalent chain group}—O—CO—{a divalent cyclic group}—{a divalent chain group}—

L-14: —CO—O—{a divalent chain group}—O—CO—{a divalent cyclic group}—{a divalent chain group}—CO—O—

L-15: —CO—O—{a divalent chain group}—O—CO—{a divalent cyclic group}—{a divalent chain group}—O—CO—

L-16: —CO—O—{a divalent chain group}—O—CO—O—{a divalent cyclic group}—

L-17: —CO—O—{a divalent chain group}—O—CO—O—{a divalent cyclic group}—CO—O—

L-18: —CO—O—{a divalent chain group}—O—CO—O—{a divalent cyclic group}—O—CO—

L-19: —CO—O—{a divalent chain group}—O—CO—O—{a divalent cyclic group}—{a divalent chain group}—

L-20: —CO—O—{a divalent chain group}—O—CO—O—{a divalent cyclic group}—{a divalent chain group}—CO—O—

L-21: —CO—O{a divalent chain group}—O—CO—O—{a divalent cyclic group}—{a divalent chain group}—O—CO—

The term of “divalent chain group” is the general term for substituted or non-substituted alkylene group, substituted or non-substituted alkenylene group and substituted or non-substituted alkynylene group. The divalent chain group is desirably substituted or non-substituted alkylene group or substituted or non-substituted alkenylene group, and preferably non-substituted alkylene group or non-substituted alkenylene group.

The non-substituted alkylene group may have a straight chain or branched chain structure. The number of the carbon atoms included in the non-substituted alkylene group is desirably 1 to 12, preferably 2 to 10 and more preferably 2 to 8.

The alkylene chain portion of the substituted alkylene group is identically defined with the non-substituted alkylene group above and their preferred scopes are also identical. The examples of the substituent group for the alkylene group include halogen atoms.

The non-substituted alkenylene group may have a straight chain or branched chain structure. The number of the carbon atoms included in the non-substituted alkenylene group is desirably 2 to 12, preferably 2 to 10 and more preferably 2 to 8.

The alkenylene chain portion of the substituted alkenylene group is identically defined with the non-substituted alkenylene group above and their preferred scopes are also identical. The examples of the substituent group for the alkenylene group include halogen atoms.

The non-substituted alkynylene group may a have straight chain or branched chain structure. The number of the carbon atoms included in the non-substituted alkynylene group is desirably 2 to 12, preferably 2 to 10 and more preferably 2 to 8.

The alkynylene chain portion of the substituted alkynylene group is identically defined with the non-substituted alkynylene group above and their preferred scopes are also identical. The examples of the substituent group for the alkynylene group include halogen atoms.

The specific examples of the divalent chain group include ethylene, trimethylene, propylene, butamethylene, 1-methyl-butamethylene, pentamethylene, hexamethylene, octamethylene, 2-buthenylene and 2-butynylene.

The divalent cyclic group is identically defined with Cy¹, Cy² and Cy³ to be hereinafter described and their preferred examples are identical.

L² and L³ respectively denote a single bond or divalent linking group. Preferably, L² and L³ respectively denote a single bond or divalent linking group selected from the group consisting of —O—, —S—, —CO—, —NR²—, a divalent chain group, divalent cyclic groups and any combinations thereof. R² is hydrogen or C1-7 alkyl group, desirably hydrogen or C1-4 alkyl group, preferably hydrogen, methyl or ethyl, and more preferably hydrogen. The divalent chain group and divalent cyclic group are identically defined with them denoted respectively by L¹ and L⁴.

In the Formula (I), n is 0, 1 or 2. When n is 2, two of L³ may be identical or different and two of Cy² may also be identical or different. n is desirably 1 or 2, and preferably 1.

In the Formula (I), Cy¹, Cy² and Cy³ respectively denote a divalent cyclic group.

The divalent cyclic group includes at least a ring, desirably a five-membered, six-membered or seven-membered ring, preferably a five-membered or six-membered ring and more preferably a six-membered ring. The divalent cyclic group may include a condensed ring, however, non-condensed rings are preferred to condensed rings. The divalent cyclic group may include an aromatic, aliphatic or hetero ring. The examples of the aromatic ring include benzene and naphthalene ring. The examples of the aliphatic ring include cyclohexane ring. The examples of the hetero ring include pyridine and pyrimidine ring.

Among the divalent cyclic groups including a benzene ring, 1,4-phenylene is desirable. Among the divalent cyclic groups including a naphthalene ring, naphthalene-1,5-diyl and naphthalene-2,6-diyl are desirable. Among the divalent cyclic groups including a cyclohexane ring, 1,4-cyclohexylene is desirable. Among the divalent cyclic groups including a pyridine ring, pyridine-2,5-diyl is desirable. Among the divalent cyclic groups including a pyrimidine ring, pyrimidine-2,5-diyl is desirable.

The divalent cyclic group may be substituted or non-substituted. The examples of the substituent for the divalent cyclic group include halogen atoms, cyano, nitro, C1-5 alkyl group, C1-5 alkyl halide group, C1-5 alkoxy group, C1-5 alkylthio group, C2-6 acyloxy group, C2-6 alkoxycarbonyl group, carbamoyl, C2-6 alkylcarbamoyl group and C2-6 acylamino group.

The specific examples of the polymerizable liquid-crystalline compounds denoted by the Formula (I) are shown bellow, however, liquid-crystalline compounds that can be employed in the present invention are not limited to these compounds.

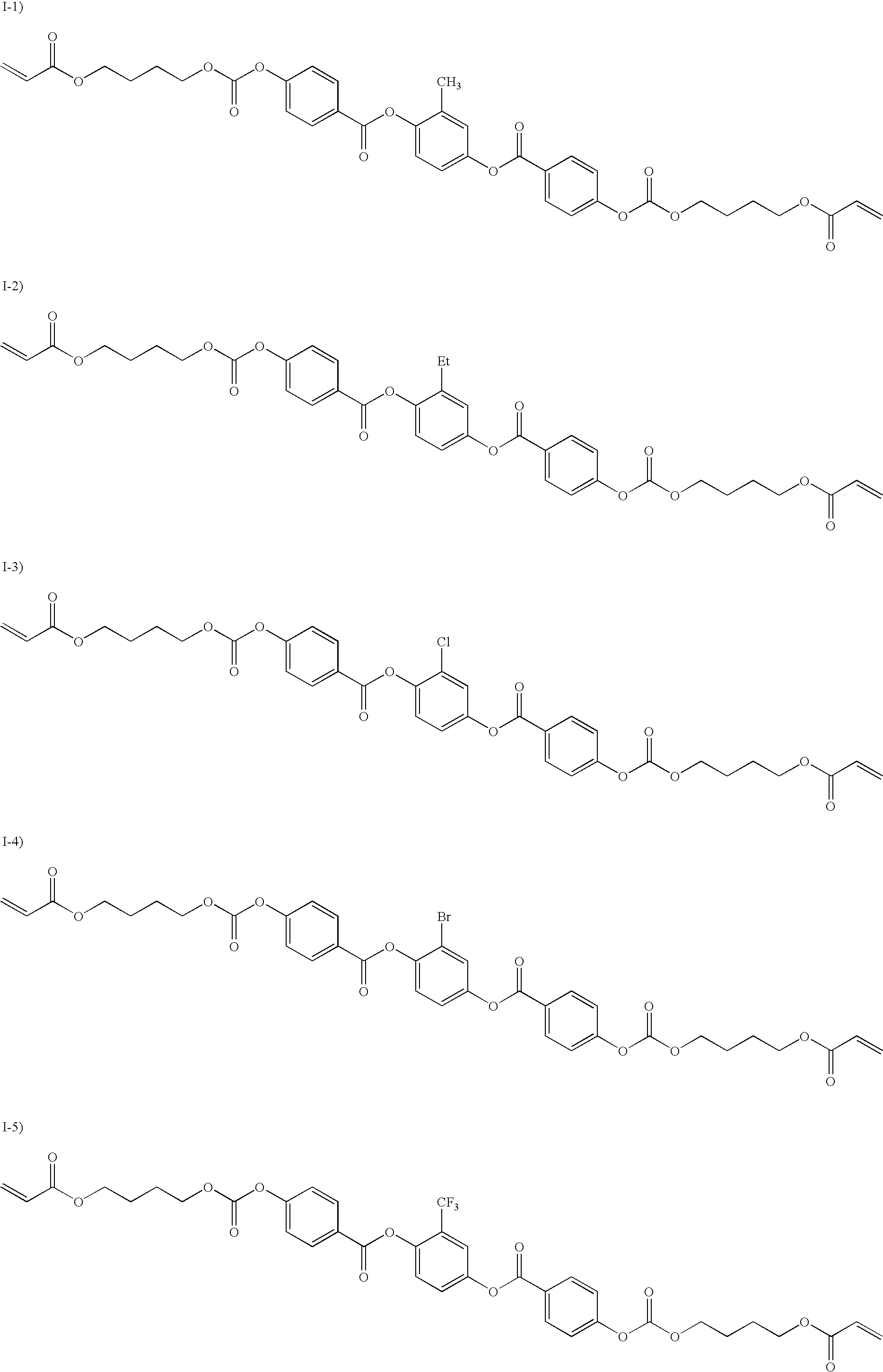

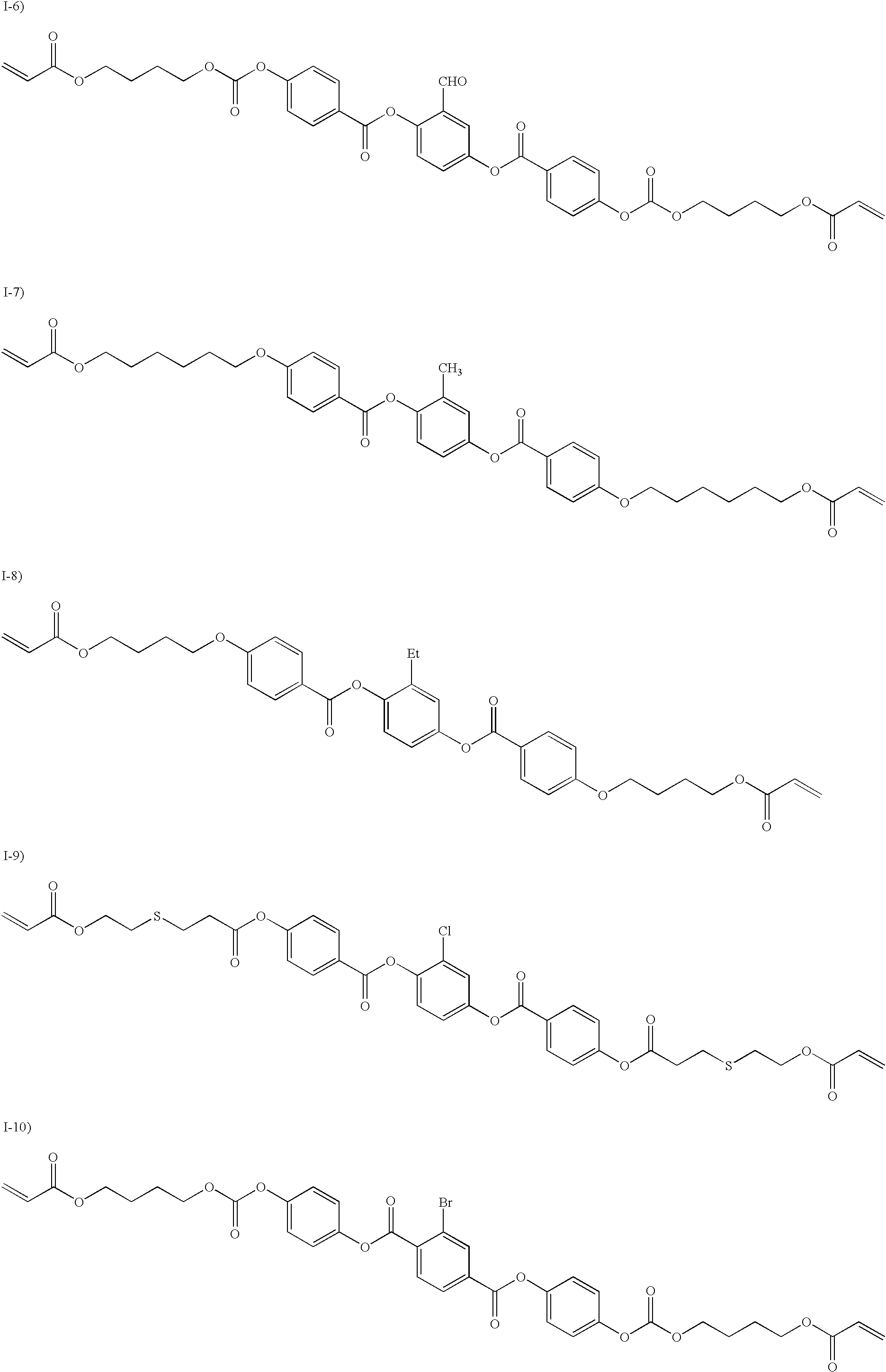

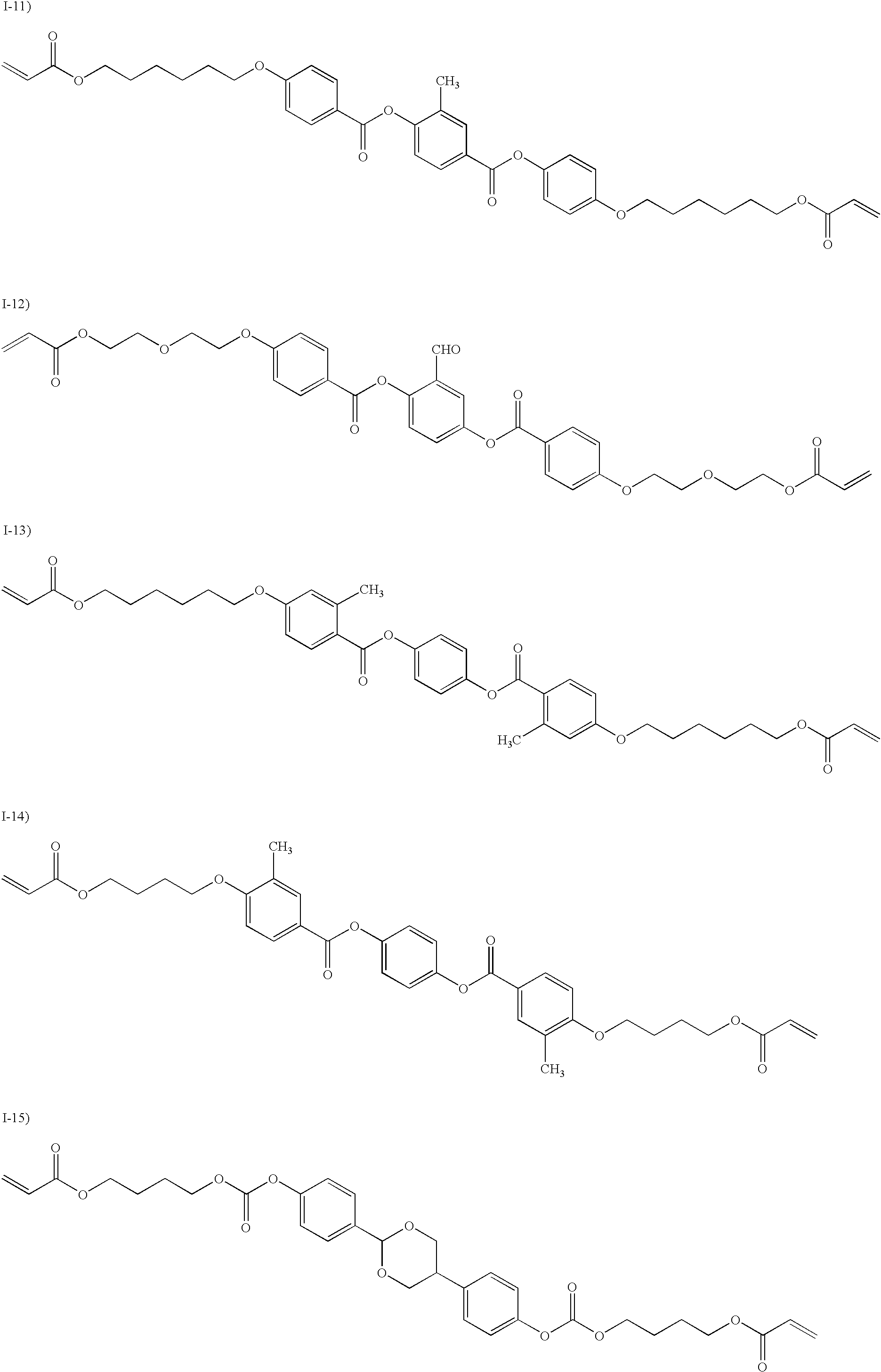

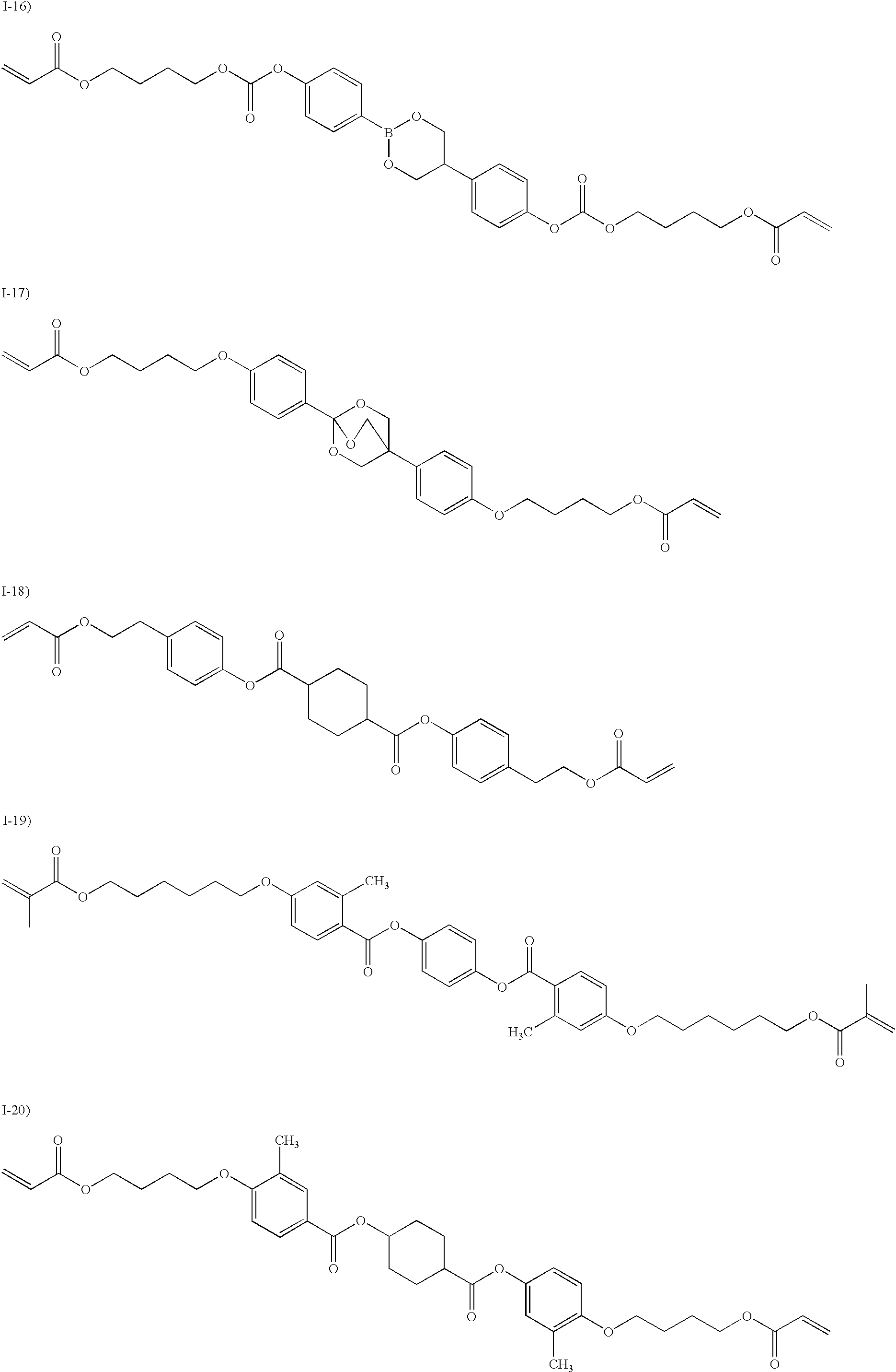

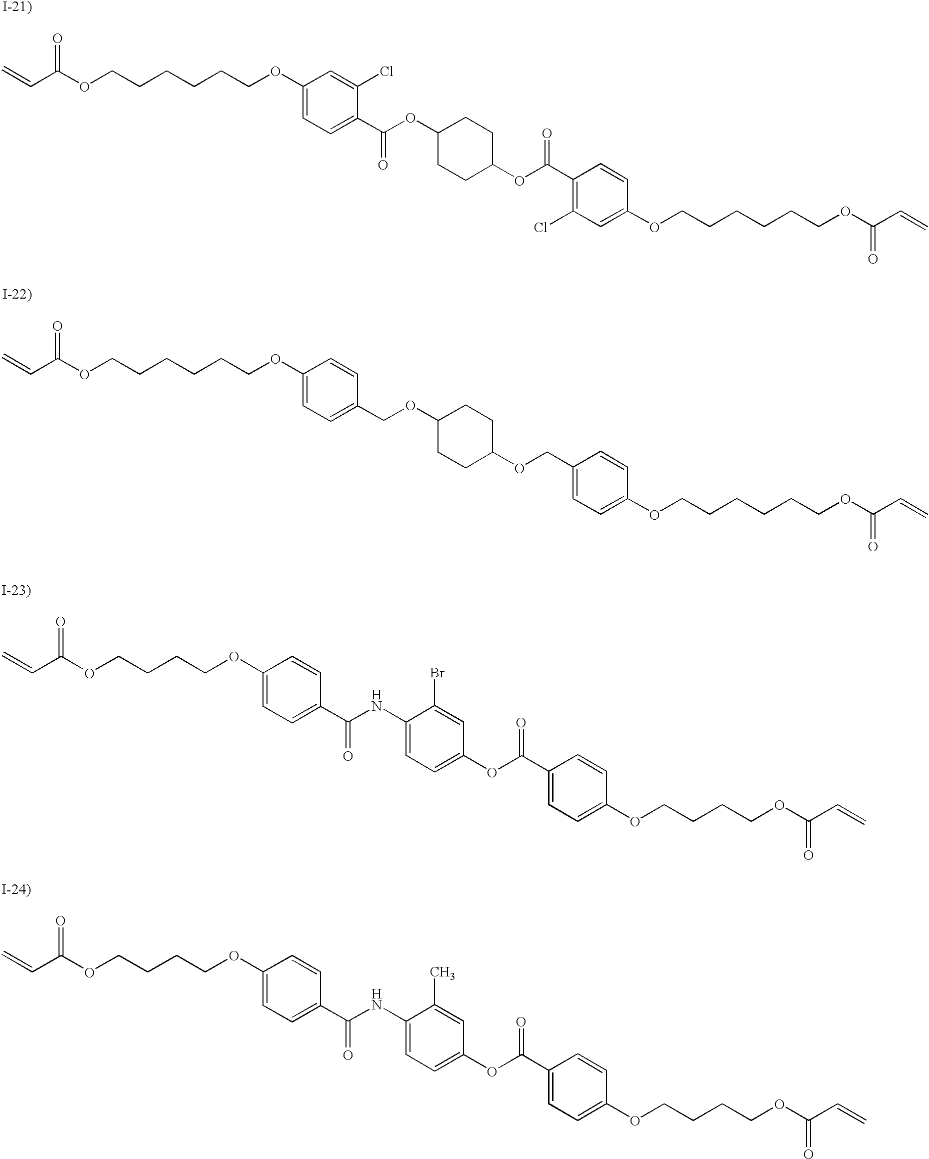

The first and second optically anisotropic layers are desirably prepared by applying a composition (coating solution) comprising a rod-like liquid-crystalline compound, and if necessary additives, to a surface of an alignment layer. Any organic solvents may be used for preparing the coating solution. The examples of the organic solvents include amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform, dichloromethane), esters (e.g., methyl acetate, butyl acetate), ketones (e.g., acetone, methyl ethyl ketone) and ethers (e.g., tetrahydrofuran, 1,2-dimethoxyethane). Alkyl halides and ketones are preferred. Two or more organic solvents may be used in combination. The coating solution may be applied by known techniques (e.g., extrusion coating, direct gravure coating, reverse gravure coating, die coating).

The rod-like molecules in the layers are desirably fixed in an alignment state, preferably fixed by the polymerization reaction of the polymerizable groups (Q¹ and Q²) included in the liquid-crystalline molecules. The polymerization reaction may be carried out in a manner of a thermal polymerization reaction with a thermal polymerization initiator or in a manner of a photo-polymerization reaction with a photo-polymerization initiator. Photo-polymerization reaction is preferred. The examples of photo-polymerization initiators include alpha-carbonyl compounds (described in U.S. Pat. Nos. 2,367,661 and 2,367,670), acyloin ethers (described in U.S. Pat. No. 2,448,828), alpha-hydrocarbon-substituted aromatic acyloin compounds (described in U.S. Pat. No. 2,722,512), polynuclear quinone compounds (described in U.S. Pat. Nos. 3,046,127 and 2,951,758), combinations of triarylimidazole dimers and p-aminophenyl ketone (described in U.S. Pat. No. 3,549,367), acridine and phenazine compounds (described in JPA No. 1985-105667 and U.S. Pat. No. 4,239,850) and oxadiazole compounds (described in U.S. Pat. No. 4,212,970).

The amount of the photo-polymerization initiator to be used is preferably 0.01 to 20% by weight, more preferably 0.5 to 5% by weight on the basis of solids in the coating solution. Irradiation for polymerizing the liquid-crystalline molecules preferably uses UV rays. The irradiation energy is preferably 20 mJ/cm² to 50 J/cm², and more preferably 100 to 800 mJ/cm². Irradiation may be performed under heating to accelerate the photo-polymerization reaction.

The thickness of the optically anisotropic layer is preferably 0.1 to 10 micro meters, more preferably 0.5 to 5 micro meters.

[Alignment Controlling Additives at Air Interface Side]

In general, rod-like liquid-crystalline molecules can be aligned homogeneously in the area near to the alignment layer interface, and on the other hand, they tend to be aligned with a certain level of tilt angles in the area near to the air interface. It is effective to use an additive to suppress such their tendencies, and it is particularly preferable to use the additives denoted by the formula (V) below. The amount of the additive is desirably from 0.01 to 5 wt % with respect to the amount of the liquid-crystalline compound.

(Hb—L⁵²—)ₙB⁵¹ Formula (V)

In the Formula (V), Hb represents a C6-40 aliphatic group, or oligosiloxanoxy group having a C6-40 aliphatic group. Hb is preferably a C6-40 aliphatic group, more preferably a fluorine-substituted C6-40 aliphatic group or a branched C6-40 aliphatic group, and most preferably a fluorine-substituted C6-40 alkyl group or a branched C6-40 alkyl group.

Among the aliphatic groups, chain aliphatic groups are preferred to rather than cyclic aliphatic groups. The chain aliphatic groups may have a straight or branched chain structure. The number of carbon atoms of the aliphatic group is preferably 7 to 35, more preferably 8 to 30, still more preferably 9 to 25, and most preferably 10 to 20.

In the specification, the term of “aliphatic group” is a general term for a substituted or non-substituted alkyl group, substituted or non-substituted alkenyl group and substituted or non-substituted alkynyl group. The aliphatic group is desirably a substituted or non-substituted alkyl group, or substituted or non-substituted alkenyl group, and preferably a substituted or non-substituted alkyl group.

The examples of the substituent of the aliphatic group include halogen atoms, hydroxy, cyano, nitro, alkoxy group, substituted alkoxy group (e.g., oligoalkoxy group), alkenyloxy group (e.g., vinyloxy), acyl group (e.g., acryloyl, methacryloyl), acyloxy group (e.g., acryloyloxy, benzoyloxy), sulfamoyl group, sulfamoyl groups substituted with aliphatic groups and epoxy alkyl group (e.g., epoxy ethyl). Among them, halogen atoms are desirable, and fluorine is more desirable, as substituent. Fluorinated aliphatic group is an aliphatic group in which part or all of the hydrogen atoms have been substituted with fluorine atoms. 50 to 100 percent of the hydrogen atoms in the aliphatic group are desirably substituted with fluorine atoms, with 60 to 100 percent substitution being preferred, 80 to 100 percent substitution being of even greater preference and 85 to 100 percent substitution being of even much greater preference.

The number of the carbon atoms included in the oligosiloxanoxy group having an aliphatic group is desirably from 7 to 35, preferably from 8 to 30, more preferably from 9 to 25 and much more preferably from 10to 20. The oligosiloxanoxy group having an aliphatic group can be denoted by the following formula:

R⁵¹—(Si(R⁵²)₂—O)_{q}—.

In the formula, R⁵¹ is hydrogen, hydroxy or aliphatic group; R⁵² is hydrogen, aliphatic group or alkoxy group; and q is an integer from 1 to 12. A chain aliphatic group is preferred to a cyclic aliphatic group as the aliphatic group denoted by R⁵¹ or R⁵². The chain aliphatic group may have a straight chain or branched chain structure. The number of the carbon atoms included in the aliphatic group is desirably from 1 to 12, preferably from 1 to 8, more preferably from 1 to 6 and much more preferably from 1 to 4.

The aliphatic group denoted respectively by R⁵¹ or R⁵² is a substituted or non-substituted alkyl group, substituted or non-substituted alkenyl group, or substituted or non-substituted alkynyl group. As the aliphatic group, a non-substituted alkyl group, substituted alkyl group, non-substituted alkenyl group and substituted alkenyl group are preferred, and a non-substituted and substituted alkyl group are more preferred.

The aliphatic group denoted respectively by R⁵¹ or R⁵² may be substituted with at least one of substituent such as a halogen atoms, hydroxy, cyano, nitro, alkoxy group, substituted alkoxy group (e.g., oligoalkoxy), alkenyloxy group (e.g., vinyloxy), acyl group (e.g., acryloyl, methacryloyl), acyloxy group (e.g., acryloyl oxy, benzoyl oxy), sulfamoyl, sulfamoyl group substituted with aliphatic group or epoxy alkyl group (e.g., epoxy ethyl).

The alkoxy group denoted by R⁵² may have a cyclic or straight or branched chain structure. The number of the carbon atoms included in the alkoxy group is desirably from 1 to 12, preferably from 1 to 8, more preferably from 1 to 6 and more preferably from 1 to 4.

The specific examples of Hb are shown bellow.

Hb1: n-C₁₆H₃₃—

Hb2: n-C₂₀H₄₁—

Hb3: n-C₆H₁₃—CH(n-C₄H₉)—CH₂—CH₂—

Hb4: n-C₁₂H₂₅—

Hb5: n-C₁₈H₃₇—

Hb6: n-C₁₄H₂₉—

Hb7: n-C₁₅H₃₁—

Hb8: n-C₁₀H₂₁—

Hb9: n-C₁₀H₂₁—CH(n-C₄H₉)—CH₂—CH₂—

Hb10: n-C₈F₁₇—

Hb11: n-C₈H₁₇—

Hb12: CH(CH₃)₂—{C₃H₆—CH(CH₃)}₃—C₂H₄—

Hb13: CH(CH₃)₂—{C₃H₆—CH(CH₃)}₂—C₃H₆—C(CH₃)═CH—CH₂—

Hb14: n-C₈H₁₇—CH(n-C₆H₁₃)—CH₂—CH₂—

Hb15: n-C₆H₁₃—CH(C₂H₅)—CH₂—CH₂—

Hb16: n-C₈F₁₇—CH(n-C₄F₉)—CH₂—

Hb17: n-C₈F₁₇—CF(n-C₆F₁₃)—CF₂—CF₂—

Hb18: n-C₃F₇—CF(CF₃)—CF₂—

Hb19: Si(CH₃)₃—{Si(CH₃)₂—O}₆—O—

Hb20: Si(OC₃H₇)(C₁₆F₃₃)(C₂H₄—SO₂—NH—C₈F₁₇)—O—

In the Formula (V), L⁵² is a single bond or divalent linking group. The divalent linking group is desirably a divalent linking group selected from the group consisting of -alkylene-, -fluorinated alkylene-, —O—, —S—, —CO—, —NR—, —SO₂— and any combinations thereof. R is a hydrogen atom or C1-20 alkyl group. R is desirably a hydrogen atom or C1-12 alkyl group. The number of the carbon atoms included in the alkylene or the fluorinated alkylene is desirably from 1 to 40, preferably from 1 to 30, more preferably from 1 to 20, much more preferably from 1 to 15 and further much more preferably from 1 to 12.

The specific examples of L⁵² are shown bellow. They are connected on the left to Hb and on the right to B⁵¹.

L⁵²10: single bond

L⁵²11: —O—

L⁵²12: —O—CO—

L⁵²13: —CO—C₄H₈—O—

L⁵²14: —O—C₂H₄—O—C₂H₄—O—

L⁵²15: —S—

L⁵²16: —N(n-C₁₂H₂₅)—

L⁵²17: —SO₂—N(n-C₃H₇)—CH₂CH₂—O—

L⁵²18: —O—{CF(CF₃)—CF₂—O}₃—CF(CF₃)—

In the Formula (V), n is an integer from 2 to 12. n is desirably an integer from 2 to 9, preferably from 2 to 6, more preferably 2, 3 or 4 and much more preferably 3 or 4.

In the Formula (V), B⁵¹ is an n-valent group showing an excluded volume effect and comprising at least three rings. B⁵¹ is desirably an n-valent group denoted by Formula (V-a).

(—Cy⁵¹—L⁵³—)ₙ Cy⁵² Formula (V-a)

In the Formula (V-a), Cy⁵¹is a divalent cyclic group. Cy⁵¹ is desirably a divalent aromatic hydrocarbon group or a divalent heterocyclic divalent group and more preferably a divalent aromatic hydrocarbon group.

In the specification, the term of “divalent aromatic hydrocarbon group” is a general term for a substituted or non-substituted arylene group. The examples of the arylene group include benzene -diyl, indene-diyl, naphthalene-diyl, fluorine-diyl, phenanthrene-diyl, anthracene-diyl and pyrane-diyl. The divalent aromatic hydrocarbon group is desirably benzene-diyl or naphthalene-diyl.

The examples of the substituent of the substituted arylene group include an aliphatic group, aromatic hydrocarbon group, heterocyclic group, halogen atoms, alkoxy group (e.g., methoxy, ethoxy, methoxy-ethoxy), aryloxy group (e.g., phenoxy), arylazo group (e.g., phenylazo), alkylthio group (e.g., methylthio, ethylthio, propylthio), alkylamino group (e.g., methylamino, propylamino), acyl group (e.g., acetyl, propanoyl, octanoyl, benzoyl), acyloxy group (e.g., acetoxy, pivaloyloxy, benzoyloxy), hydroxy, mercapto, amino, carboxy, sulfo, carbamoyl, sulfamoyl and ureido.

The divalent aromatic hydrocarbon group bonded to another aromatic hydrocarbon group through a single, vinylene or ethynylene bond may show the above-mentioned ability of promoting alignment of liquid-crystalline molecules. The divalent aromatic hydrocarbon group may have a group of Hb—L⁵²— as a substituent.

The hetero ring included in the divalent heterocyclic group denoted by Cy⁵¹ is desirably five-, six- or seven-membered, preferably five- or six-membered, and more preferably six-membered. The hetero atom constituting the hetero ring is desirably nitrogen, oxygen or sulfur. The hetero ring desirably has aromaticity. Aromatic hetero rings are usually unsaturated rings and desirably has maximum double bondings. The examples of the hetero ring include a furan ring, thiophene ring, pyrrole ring, pyrrolizine ring, oxazole ring, isoxazole ring, thiazole ring, isothiazole ring, imidazole ring, imidazoline ring, imidazolidine ring, pyrazole ring, pyrazolidine ring, triazole ring, furazan ring, tetrazole ring, pyrane ring, thiine ring, pyridine ring, piperidine ring, oxazine ring, morpholine ring, thiazine ring, pyridazine ring, pyrimidine ring, pyrazine ring, piperazine ring and triazine ring.

The hetero rings may be condensed with other hetero rings, aliphatic rings or aryl rings. The examples of the condensed hetero rings include a benzofuran ring, isobenzofuran ring, benzothiophene ring, indole ring, indoline ring, isoindole ring, benzoxazole ring, benzothiazole ring, indazole ring, benzoimidazole ring, chromene ring, chromane ring, isochromane ring, quinoline ring, isoquinoline ring, cinnoline ring, phthalazine ring, quinazoline ring, quinoxaline ring, di-benzofuran ring, carbazole ring, xanthene ring, acridine ring, phenanthridine ring, phenanthroline ring, phenazine ring, phenoxazine ring, thianthrene ring, indolizine ring, quinolidine ring, quinuclidine ring, naphthridine ring, purine ring and pteridine ring.

The divalent heterocyclic group may have at least one substituent. The examples of the substituent for the divalent heterocyclic group are identical with those for the substituted arylene group.

The divalent heterocyclic group, Cy⁵¹, may connected to the L⁵³or the cyclic group denoted by Cy⁵², when L⁵³ is a single bond, through a hetero atom such as nitrogen constituting a piperidine ring. The hetero atom linking them may form an onium salt such as an oxonium, sulfonium or ammonium.

The cyclic Cy⁵¹ and Cy⁵² may form a planar structure, that is, a discotic structure, as a whole. In such a case, the above-mentioned ability of promoting alignment of liquid-crystalline molecules can be obtained.

The specific examples of Cy⁵¹ are shown bellow. When the plural groups corresponding to Hb—L⁵²— are bonded to a divalent aromatic hydrocarbon group or a divalent heterocyclic group, one of the plural groups can be regarded as Hb—L⁵²— and others can be regarded as substituent of the aromatic hydrocarbon group or the heterocyclic group.

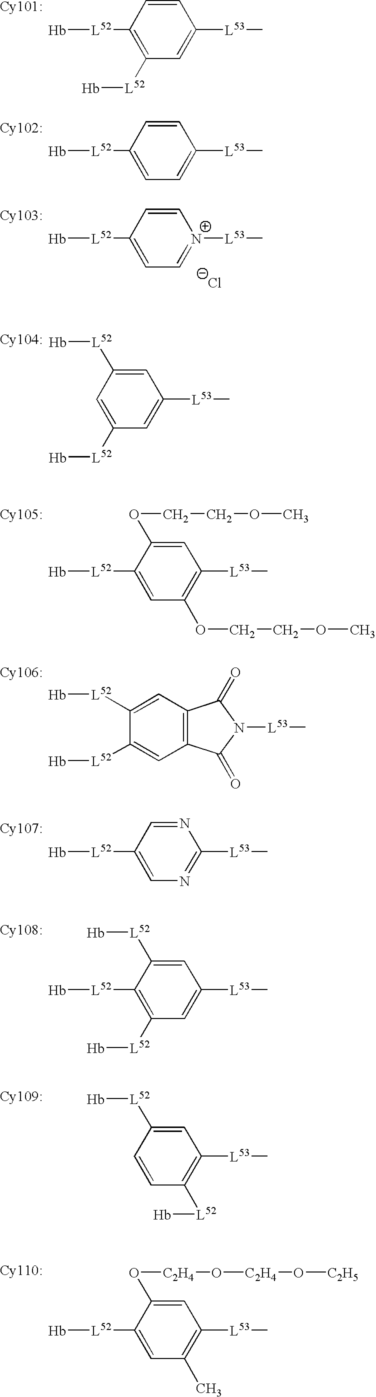

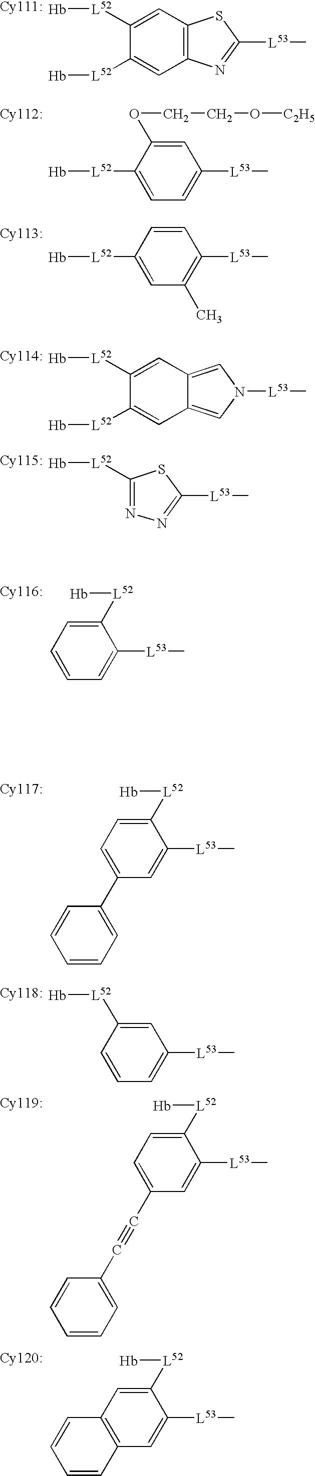

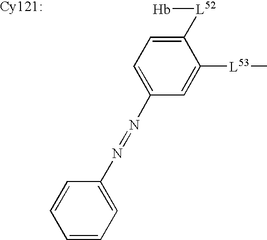

In the Formula (V-a), L⁵³ is a divalent linking group selected from the group consisting of a single bond, -alkylene-, -alkenylene-, -alkynylene-, —O—, —S—, —CO—, —NR—, —SO₂— and any combinations thereof. R is a hydrogen atom or C1-30 alkyl group. L⁵³ is desirably a divalent linking group selected from the group consisting of —O—, —S—, —CO—, —NR—, —SO₂— and any combinations thereof. R is desirably a hydrogen atom or C1-20 alkyl group, preferably a hydrogen atom or C1-15 alkyl group, and more preferably a hydrogen atom or C1-12 alkyl group.

The number of the carbon atoms included in the alkylene group is desirably from 1 to 40, preferably from 1 to 30, more preferably from 1 to 15 and much more preferably from 1 to 12.

The number of the carbon atoms included in the alkenylene group is desirably from 2 to 40, preferably from 2 to 30, more preferably from 2 to 15 and much more preferably from 2 to 12.

The specific examples of L⁵³ are shown bellow. In the following examples, the left end of an exemplified group is bonded to Cy⁵¹ and the right end is bonded to Cy⁵².

L20: single bond

L21: —S—

L22: —NH—

L23: —NH—SO₂—NH—

L24: —NH—CO—NH—

L25: —SO₂—

L26: —O—NH—

L27: —C≡C—

L28: —CH═CH—S—

L29: —CH₂—O—

L30: —N(CH₃)—

L31: —CO—O—

In the Formula (V-a), n is an integer from 2 to 12, desirably from 2 to 9, preferably from 2 to 6, more preferably 2,3 or 4, and much more preferably 3 or 4.

In the Formula (V-a), Cy⁵² is an n-valent cyclic group. Cy⁵² is desirably an n-valent aromatic hydrocarbon group or n-valent heterocyclic group.

The examples of the aromatic hydrocarbon ring included in the aromatic hydrocarbon group denoted by Cy⁵² include a benzene ring, indene ring, naphthalene ring, fluorine ring, phenanthrene ring, anthracene ring and pyrene ring. Among them, a benzene ring and naphthalene ring are preferred and a benzene ring is more preferred.

The aromatic hydrocarbon group denoted by Cy⁵² may have at least one substituent. The examples of the substituent include an aliphatic group, aromatic hydrocarbon group, heterocyclic group, halogen atom, alkoxy group (e.g., methoxy, ethoxy, methoxy-ethoxy), aryloxy group (e.g., phenoxy), arylazo group (e.g., phenylazo), alkylthio group (e.g., methylthio, ethylthio, propylthio), alkylamino group (e.g., methylamino, propylamino), arylamino group (e.g., phenylamino), acyl group (e.g., acetyl, propanoyl, octanoyl, benzoyl), acyloxy group (e.g., acetoxy, pivaloyloxy, benzoyloxy), hydroxy, mercapto, amino, carboxy, sulfo, carbamoyl, sulfamoyl and ureido.

The hetero ring included in the divalent heterocyclic group denoted by Cy⁵² is desirably five-, six- or seven-membered, preferably five- or six-membered, and more preferably six-membered. The hetero atom constituting the hetero ring is desirably nitrogen, oxygen or sulfur. The hetero ring desirably has aromaticity. Aromatic hetero rings are usually unsaturated rings and desirably has maximum double bondings. The examples of the hetero ring include a furan ring, thiophene ring, pyrrole ring, pyrroline ring, pyrrolizine ring, oxazole ring, isoxazole ring, thiazole ring, isothiazole ring, imidazole ring, imidazoline ring, imidazolidine ring, pyrazole ring, pyrazoline ring, pyrazolidine ring, triazole ring, furazan ring, tetrazole ring, pyrane ring, thiine ring, pyridine ring, piperidine ring, oxazine ring, morpholine ring, thiazine ring, pyridazine ring, pyrimidine ring, pyrazine ring, piperazine ring and triazine ring. Among them, triazine ring is preferred and 1,3,5-triazine ring is more preferred.

Although the hetero rings may be condensed with other hetero rings, aliphatic rings or aryl rings, monocyclic hetero rings are preferred.

The specific examples of Cy⁵² are shown bellow.

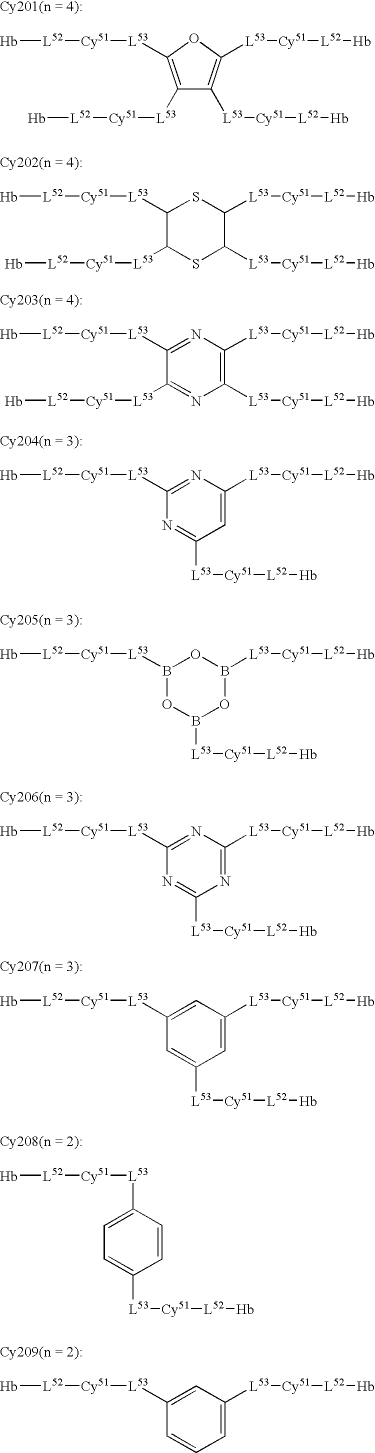

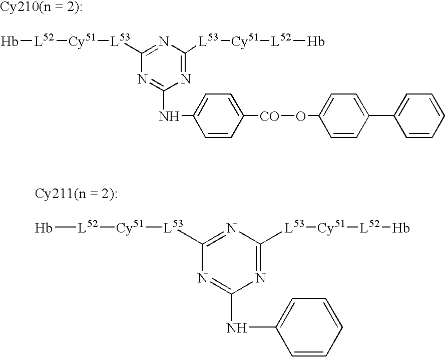

The alignment promoter is a compound comprising the aforementioned hydrophobic group (Hb), the linking group (L⁵²) and the group (Bu) showing an excluded volume effect. There is no specific limitation on the combinations thereof.

The specific examples of the alignment promoters denoted by the Formula (V) are shown below.

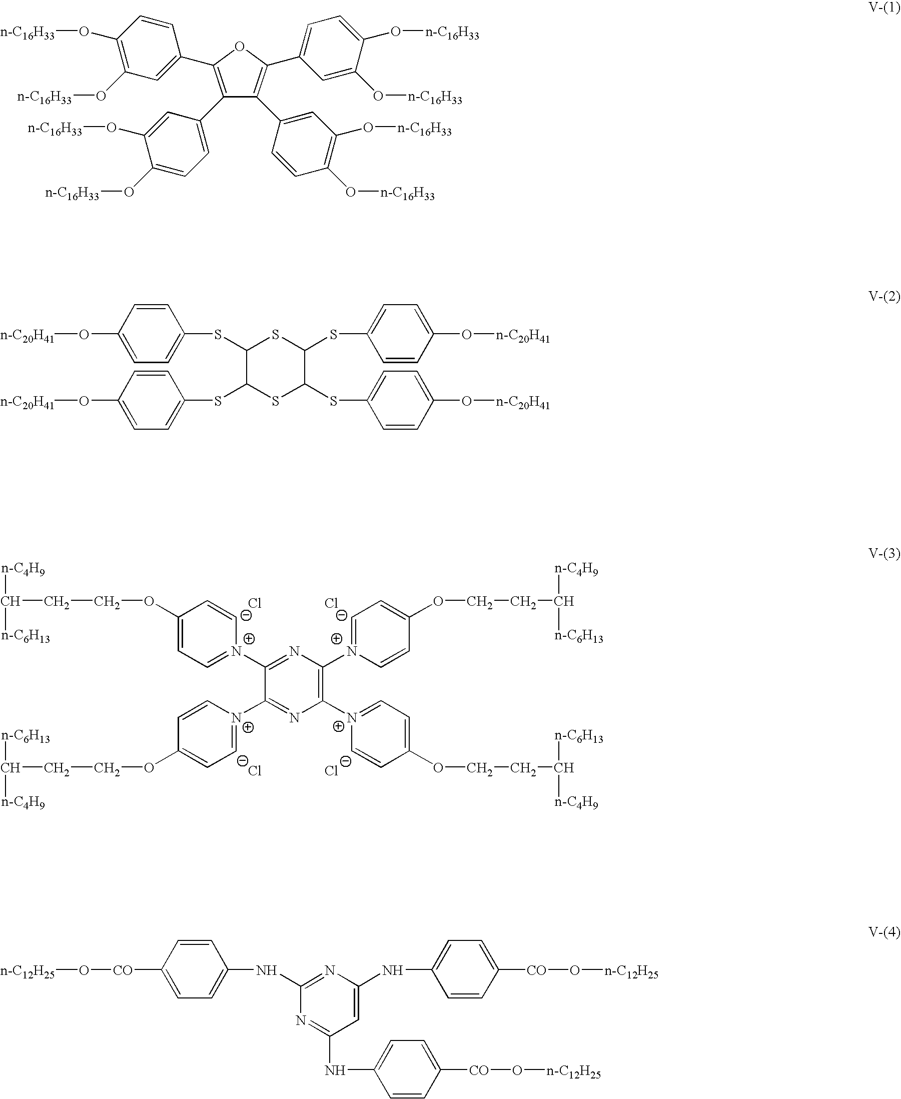

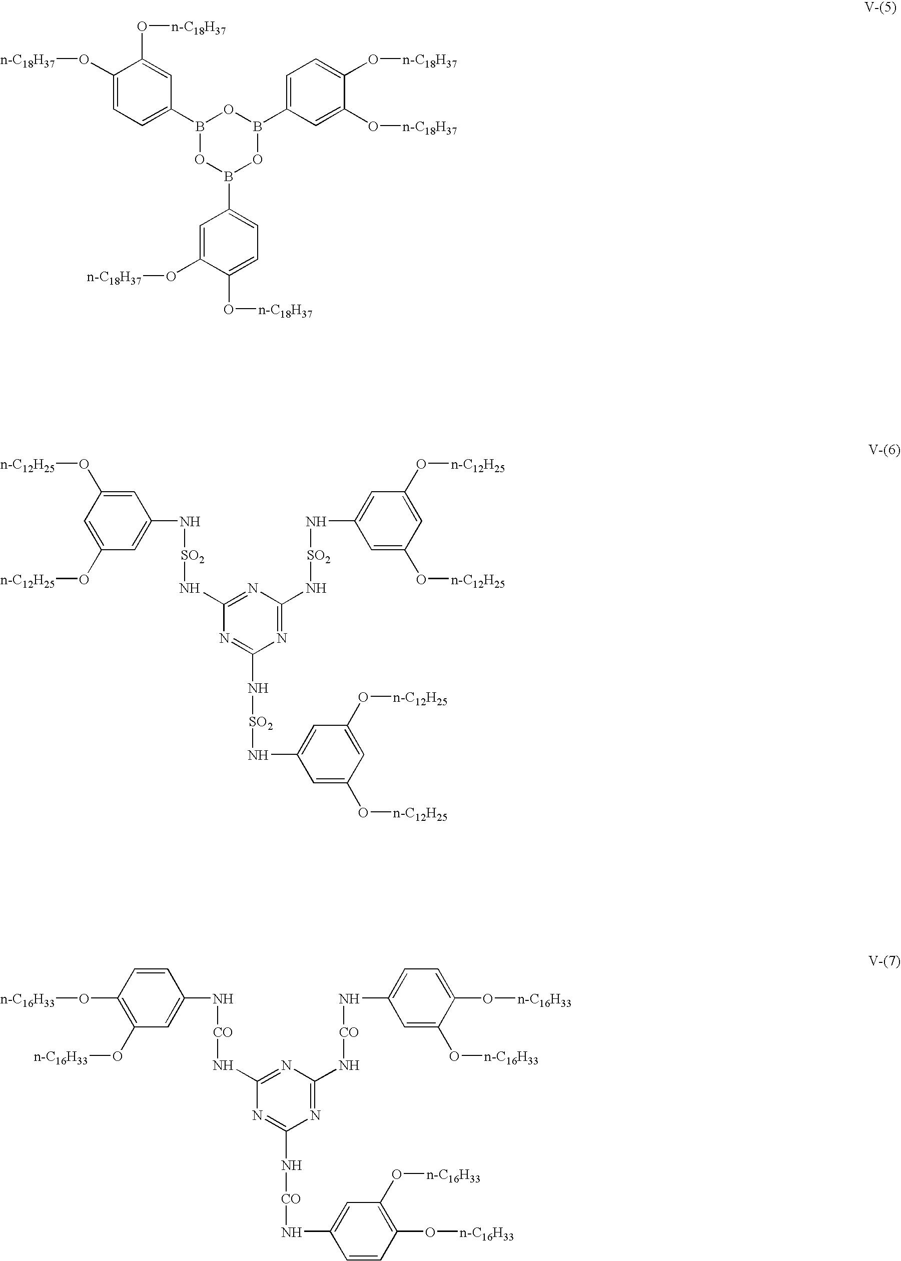

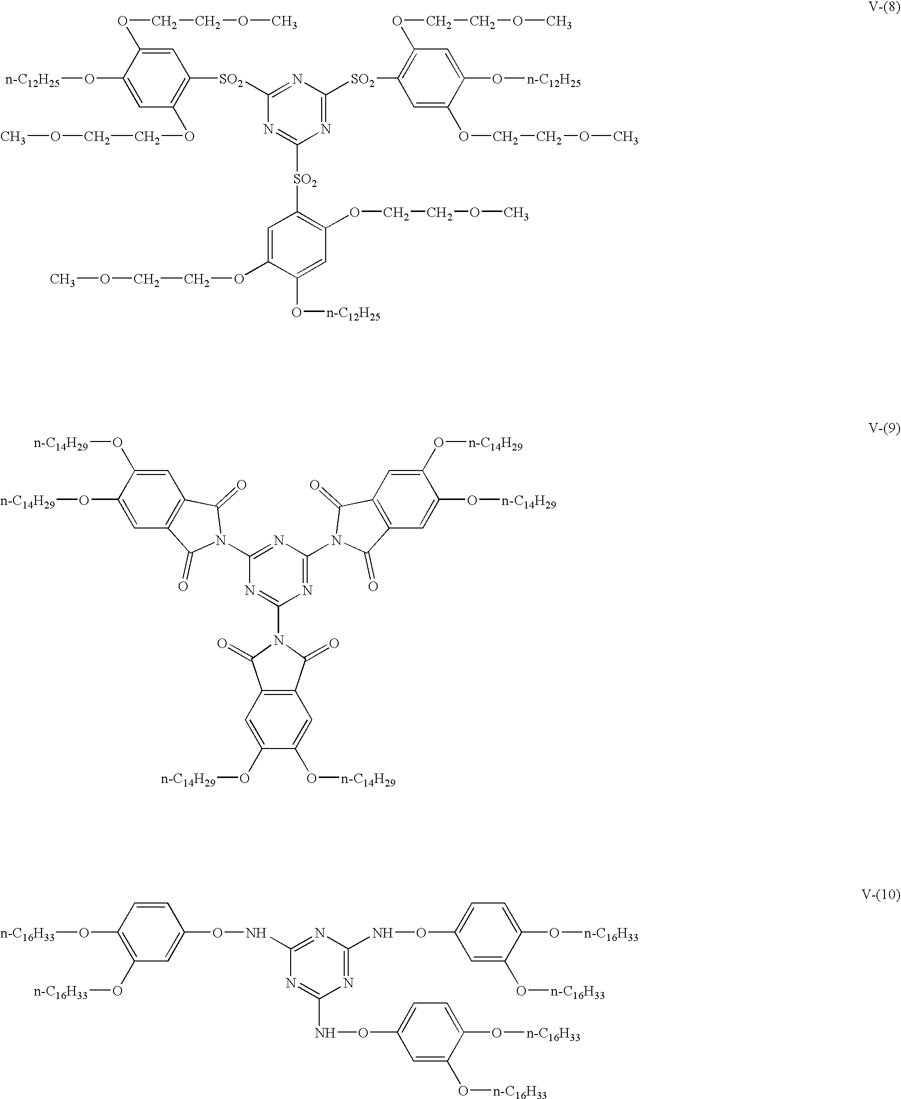

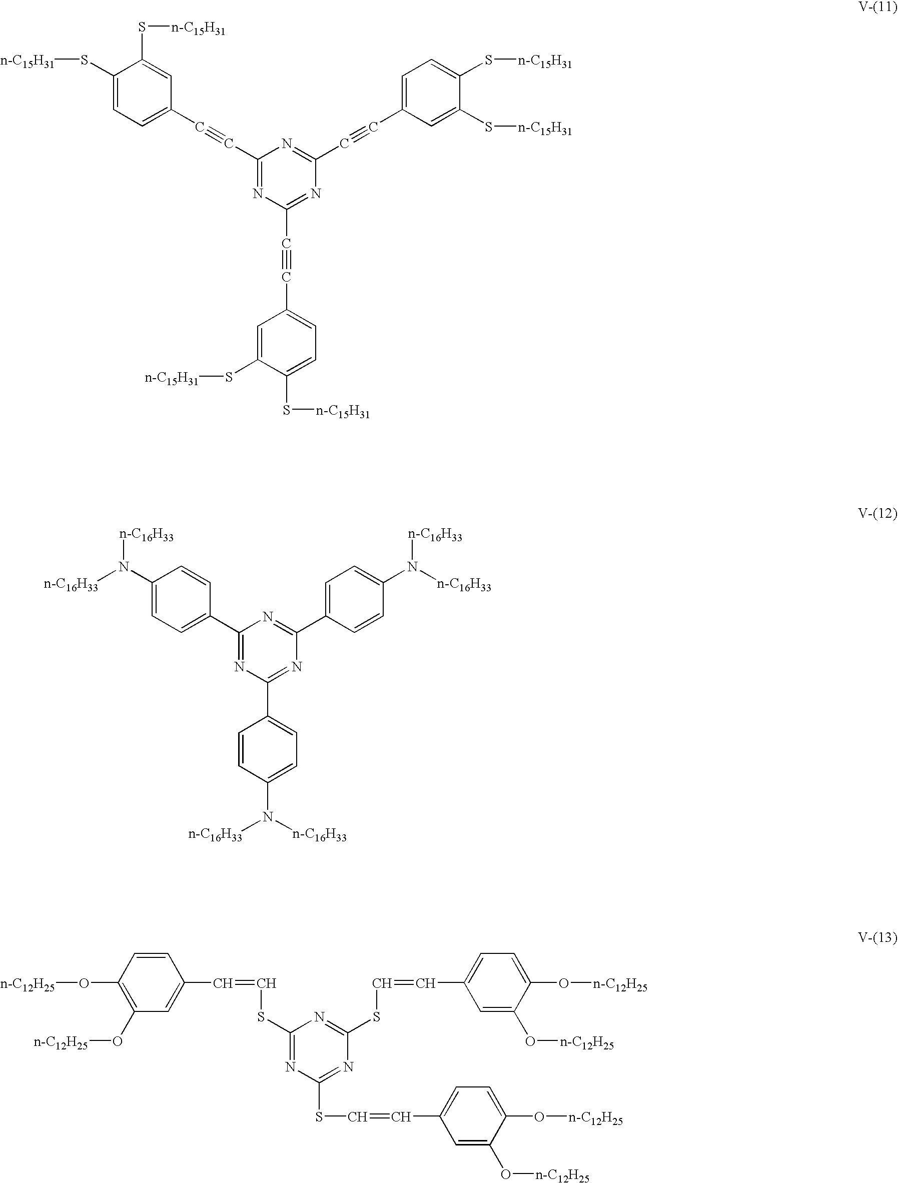

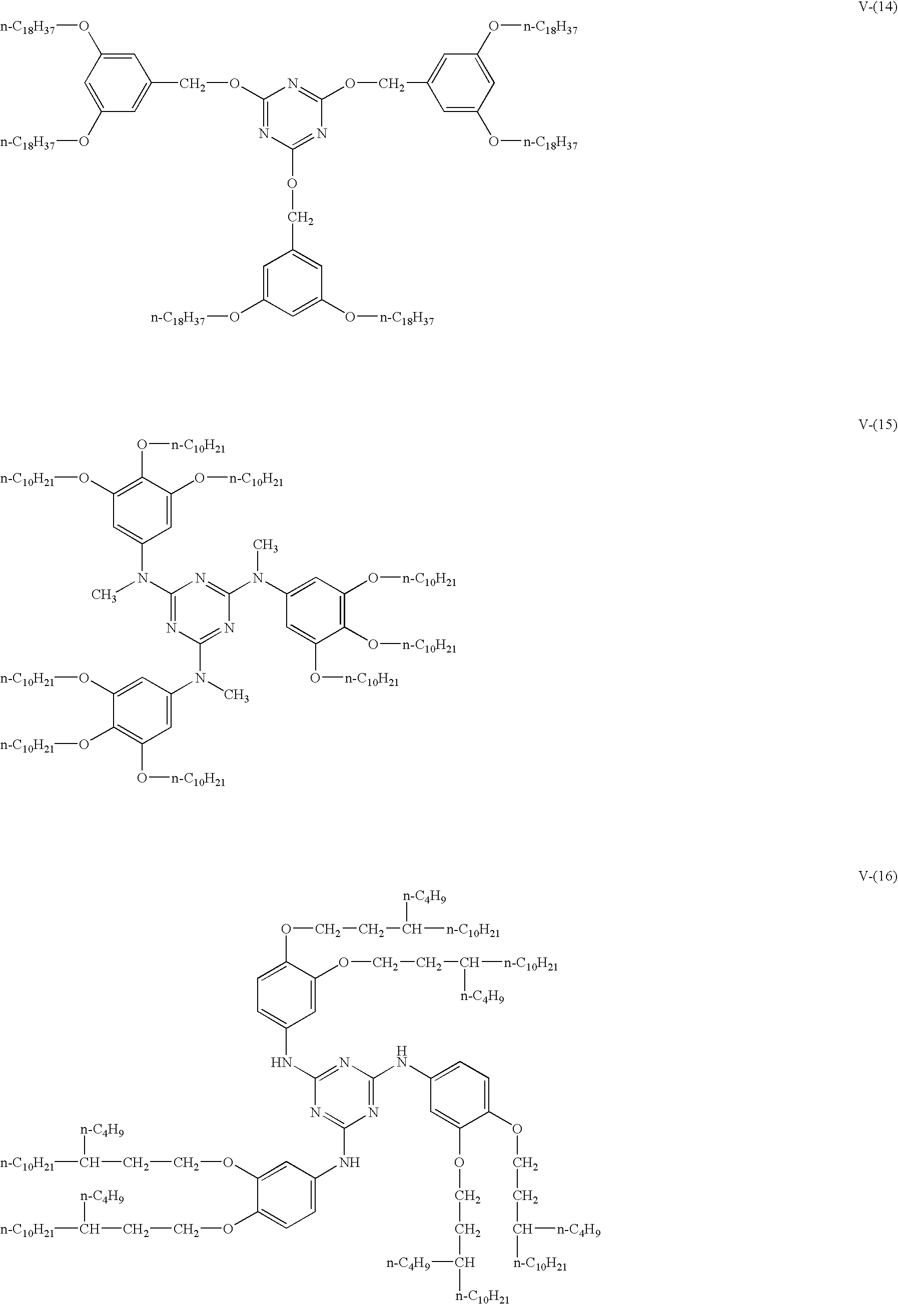

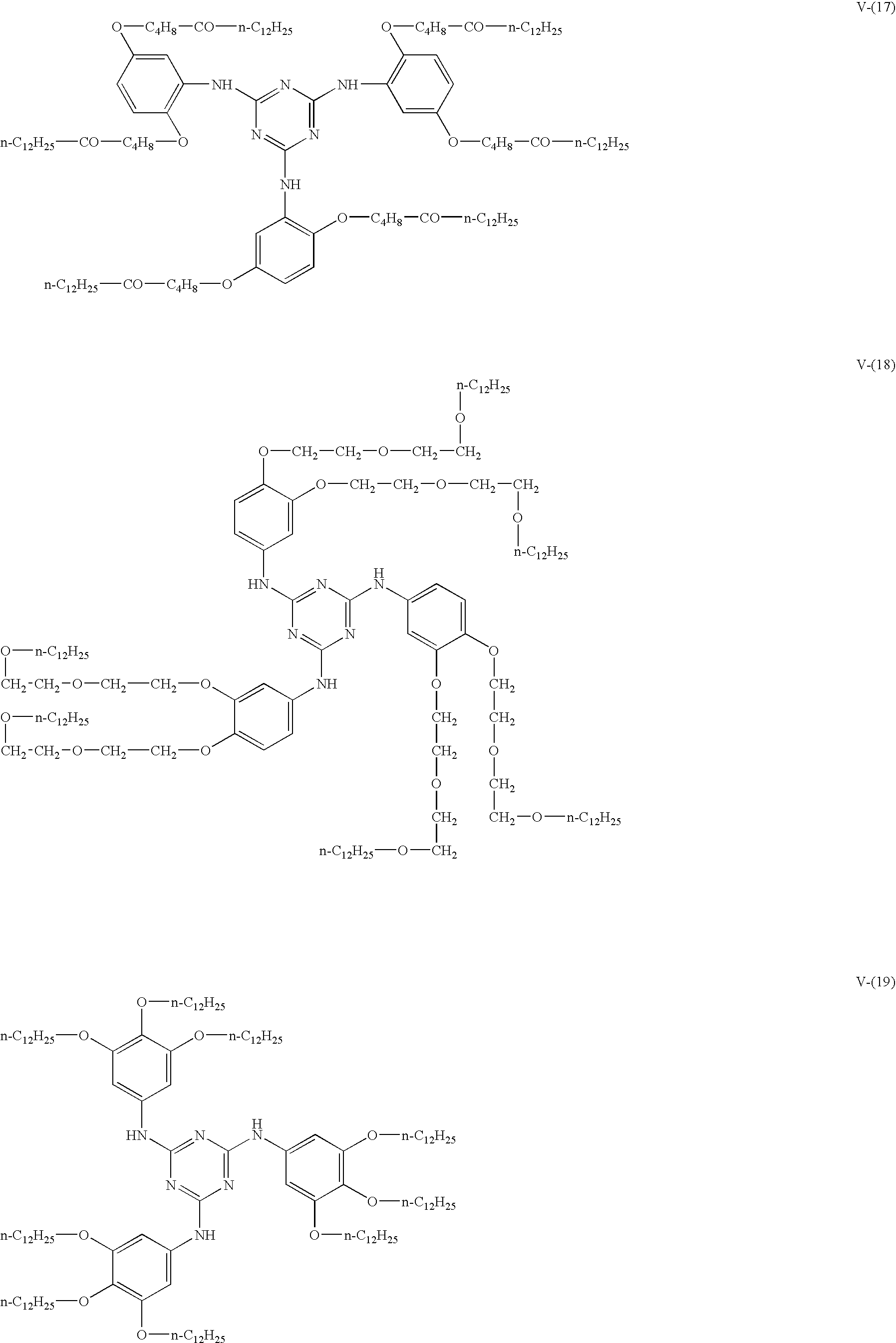

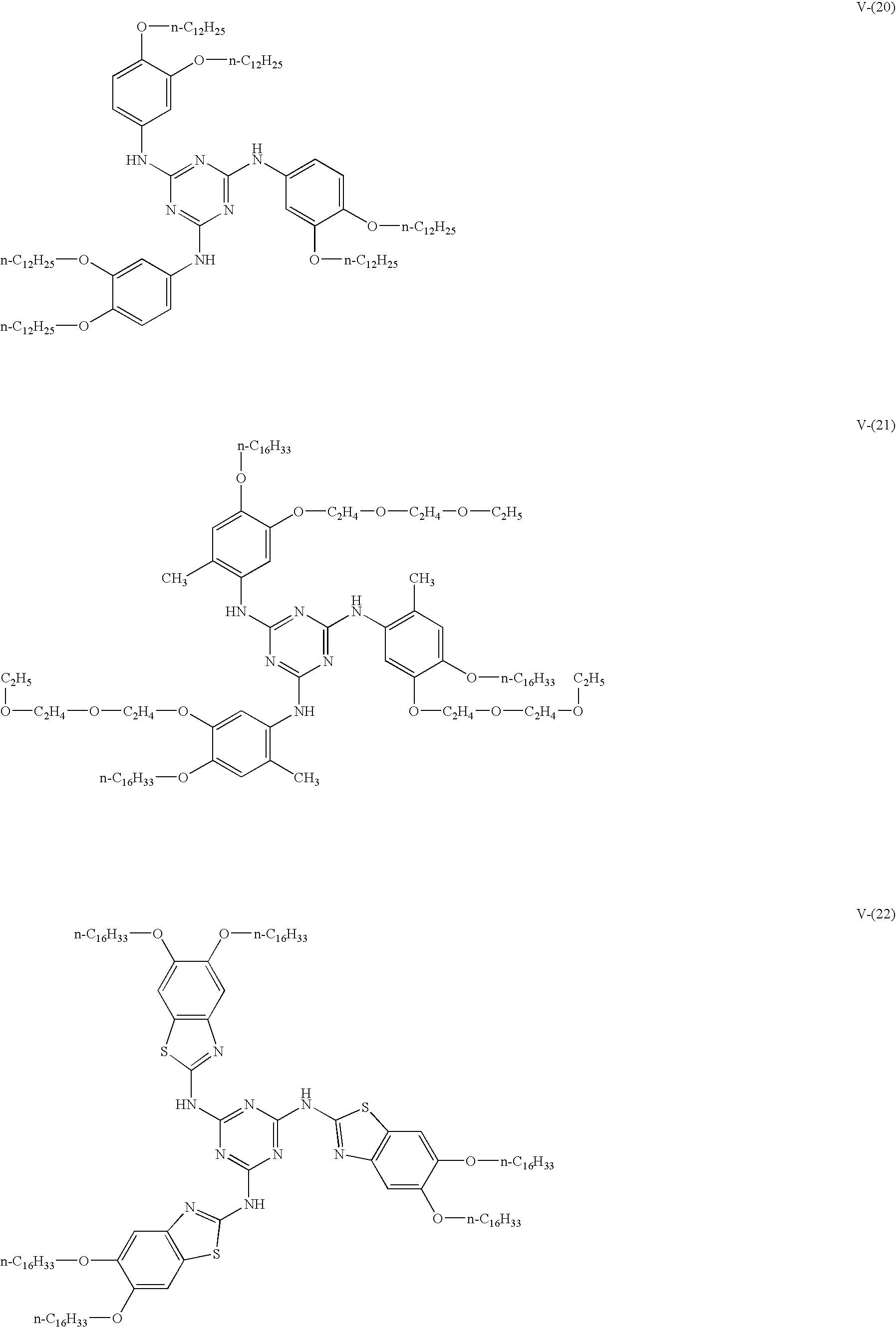

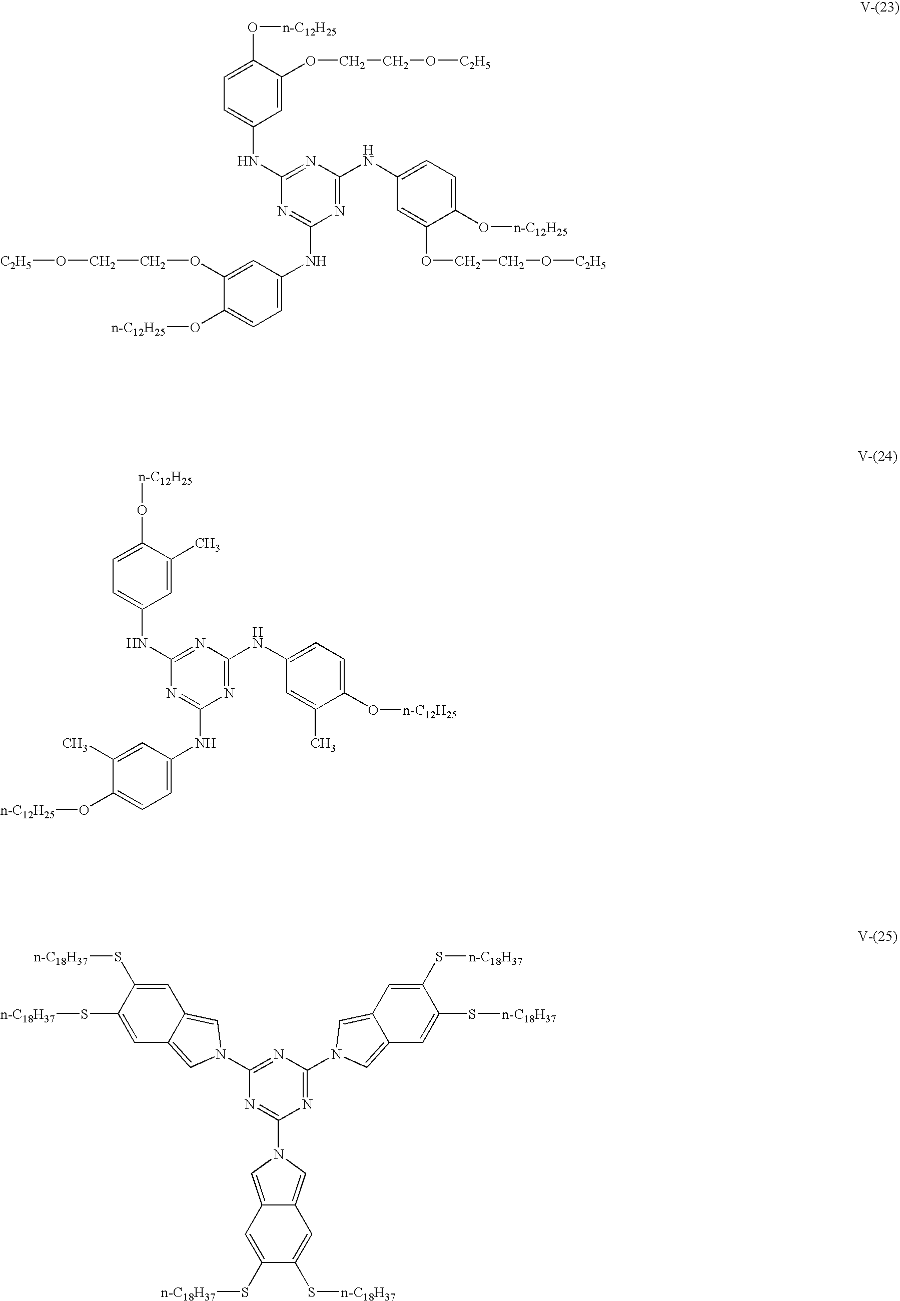

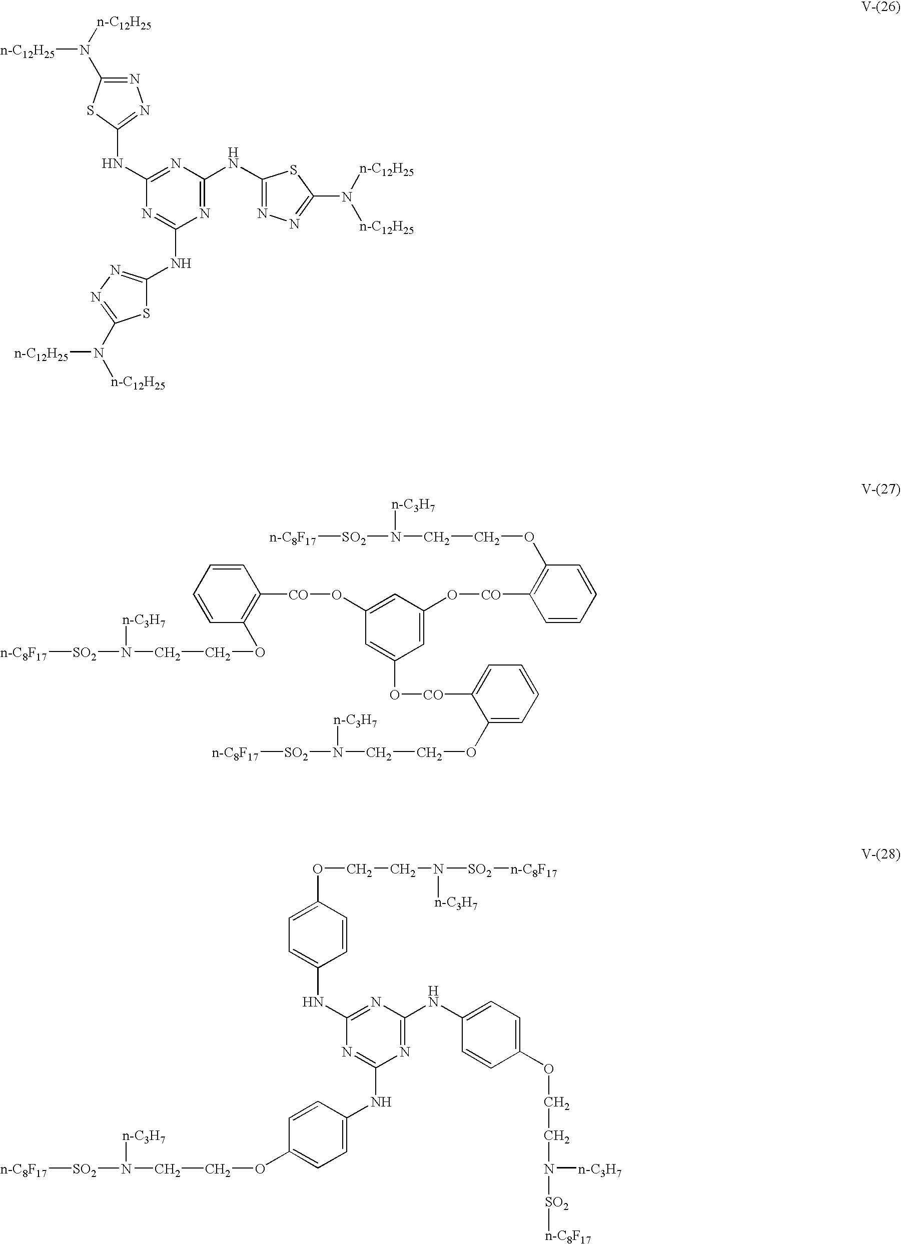

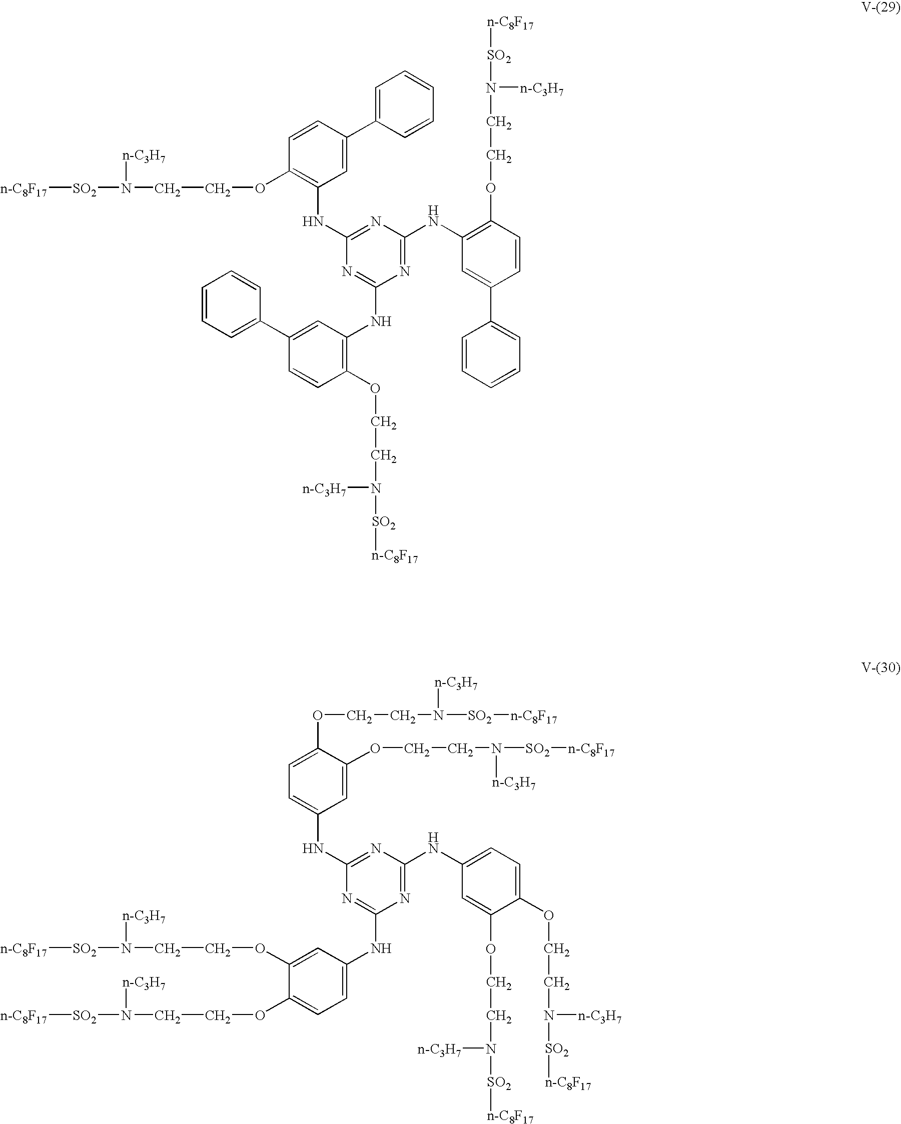

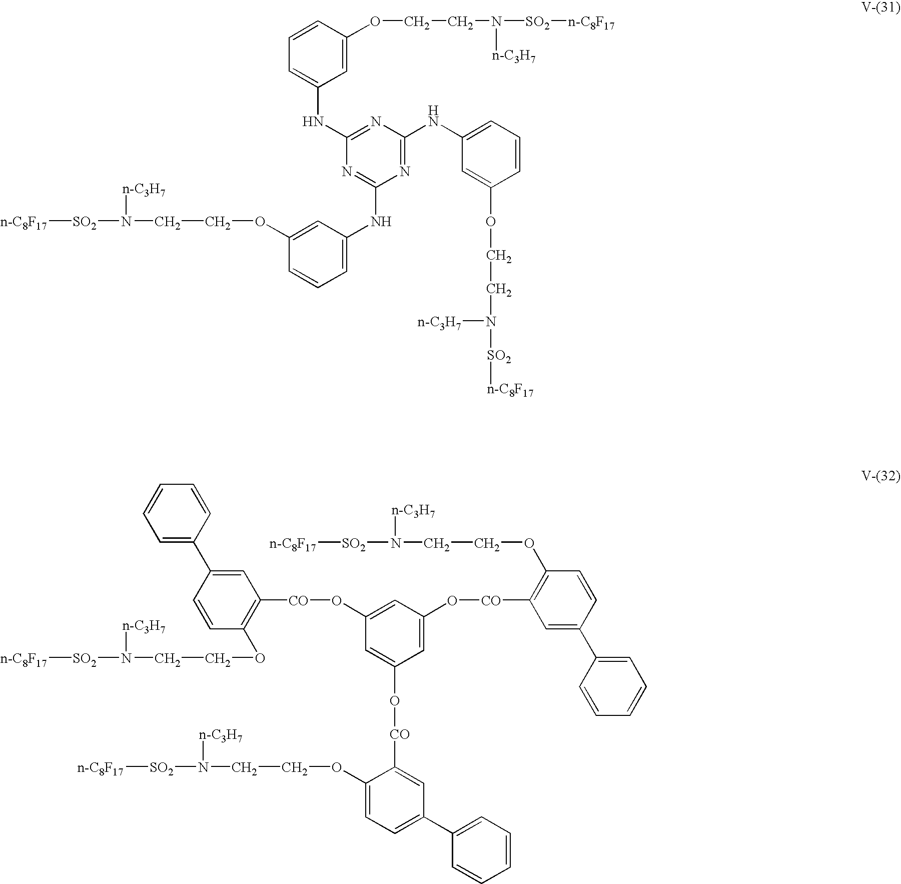

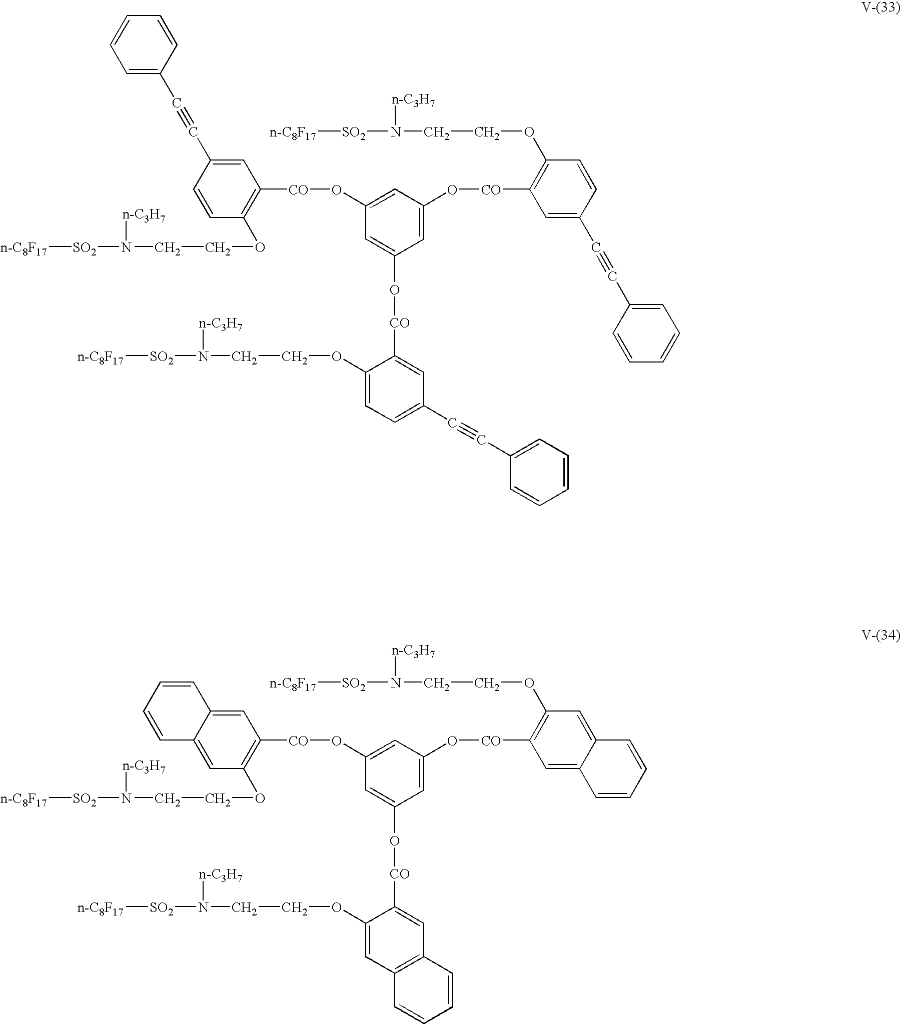

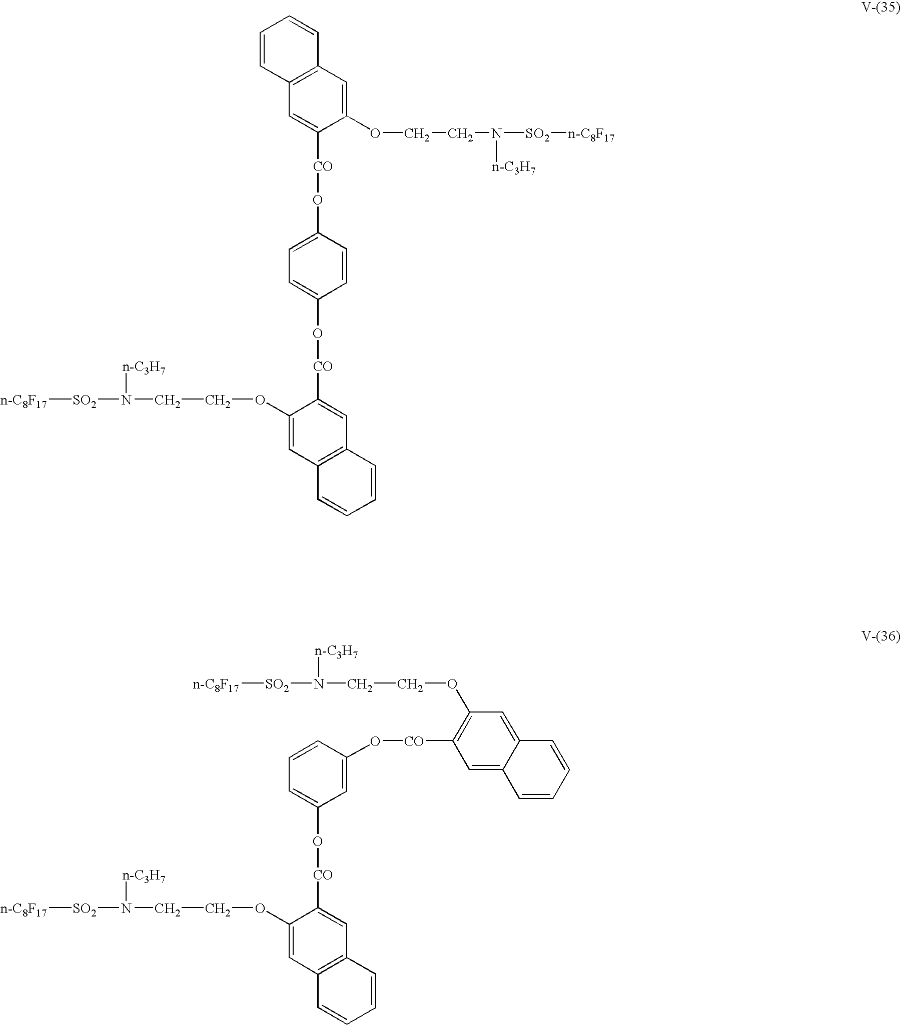

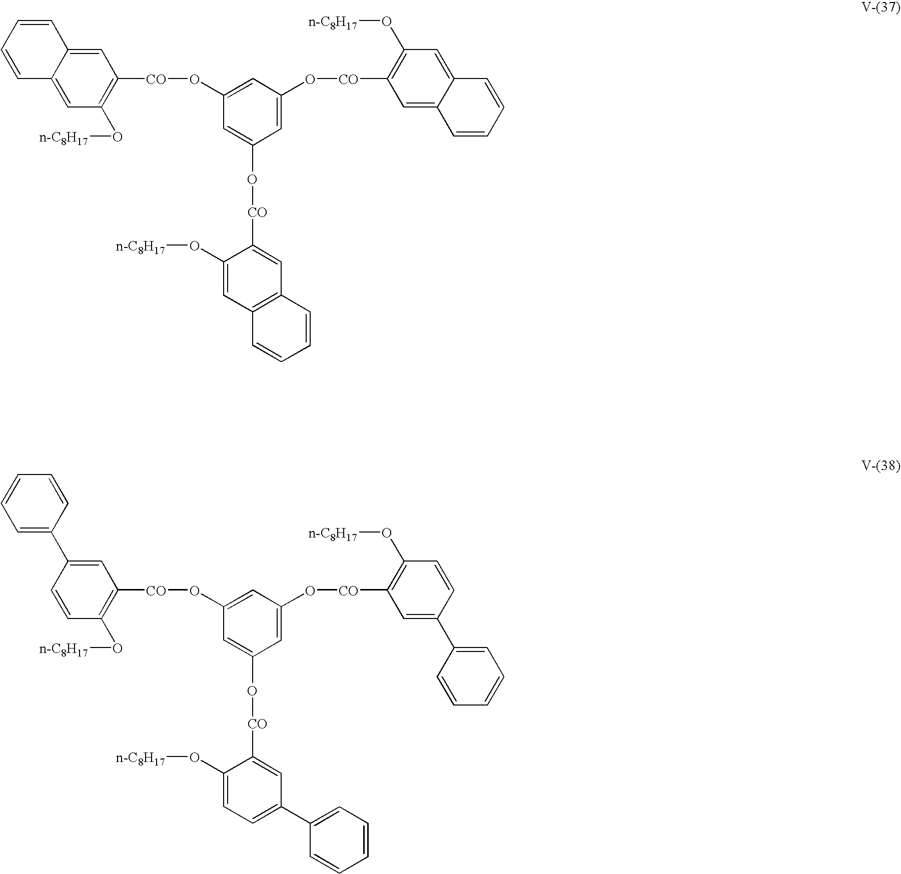

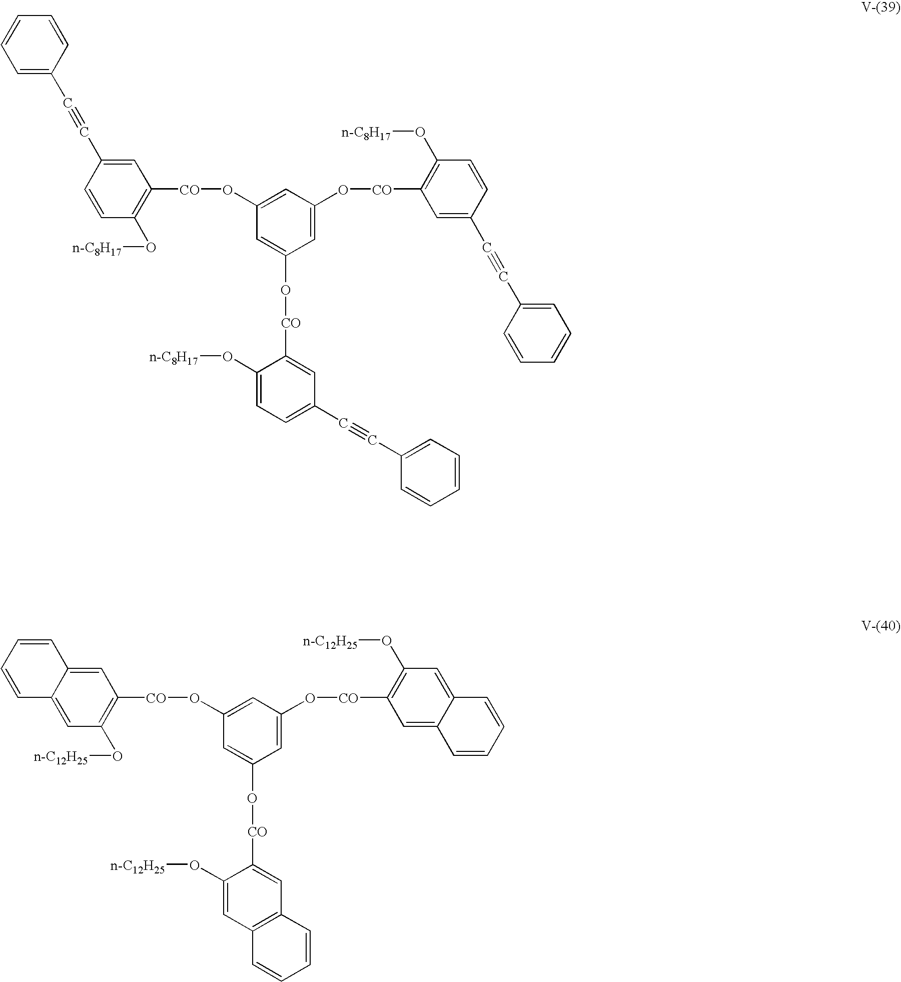

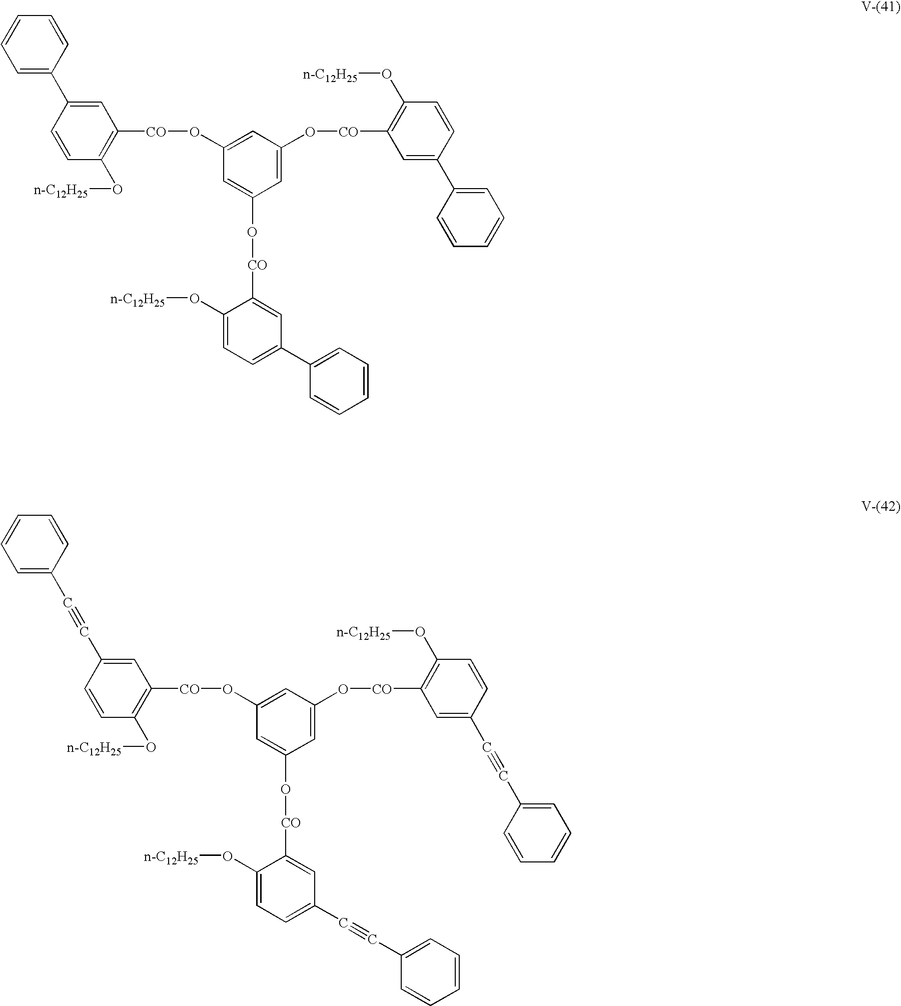

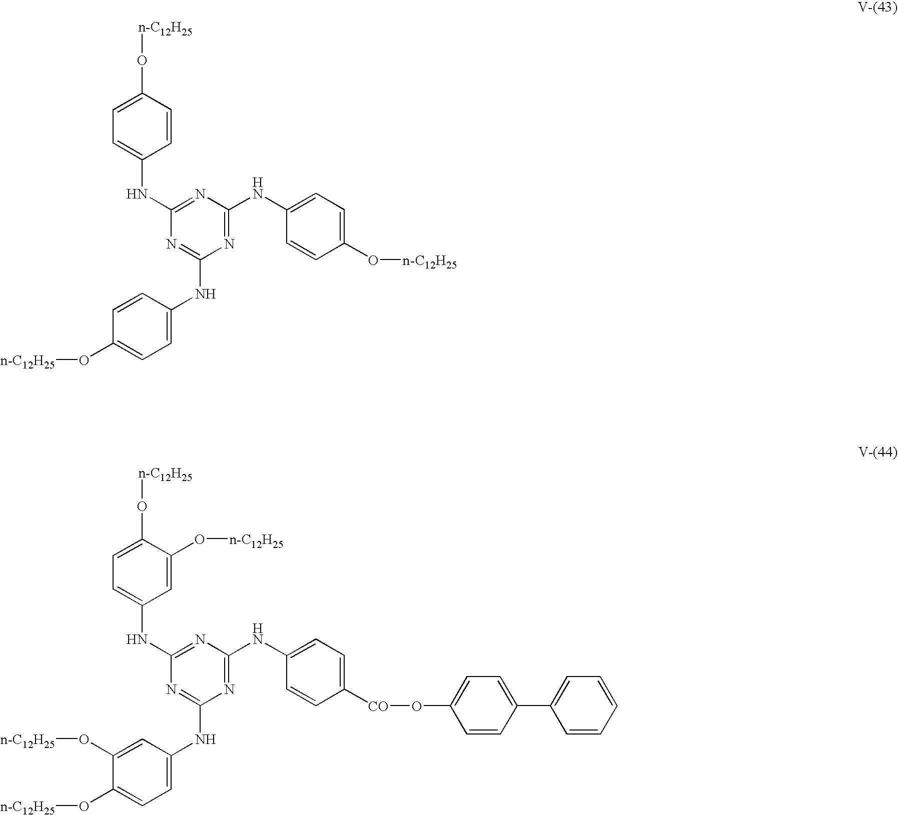

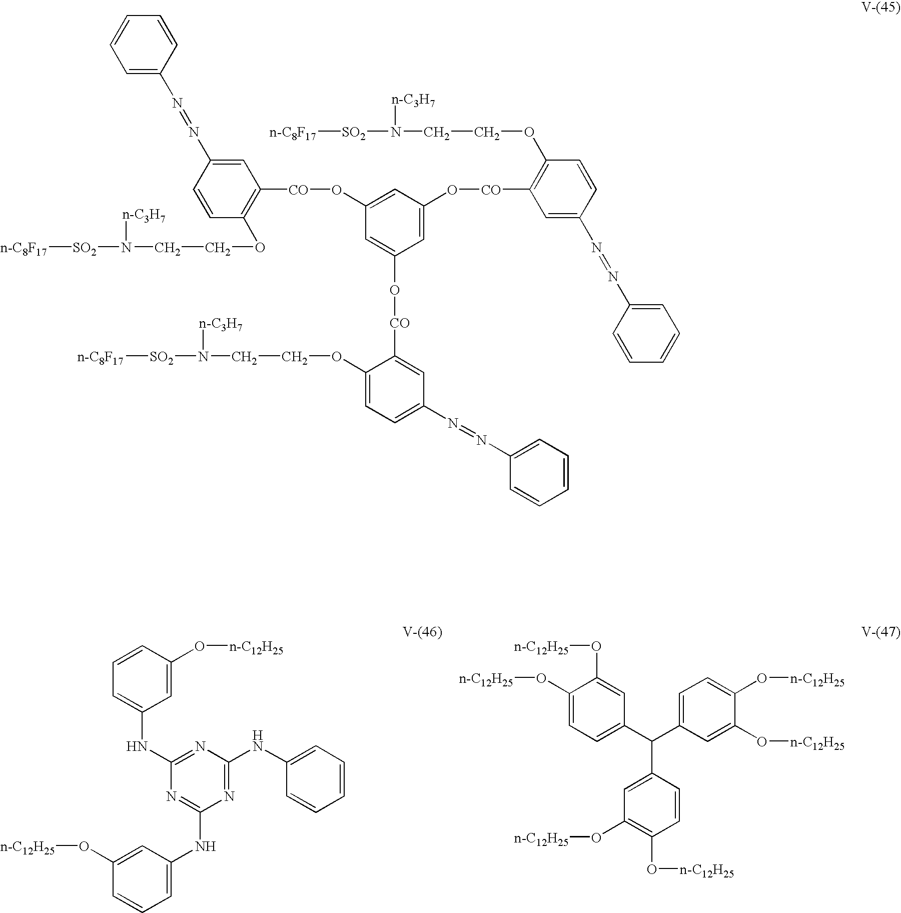

[Alignment Layer]

For aligning rod-like liquid-crystalline molecules so as to prepare the optically anisotropic layers respectively, alignment layers may be used. There have been provided alignment layers formed of various materials by various methods such as subjecting a film made of an organic compound (preferably a polymer) to a rubbing treatment, obliquely depositing an inorganic compound, forming a layer having microgrooves, or accumulating an organic compound (e.g., ω-trichosanic acid, dioctadecylmethylammonium chloride, methyl stearate) by Langmuir-Blodgett method (LB film). Alignment layers having an alignment effect under an electric or magnetic field or irradiation are also known. According to the present invention, the alignment layer prepared by subjecting a film of a polymer to a rubbing treatment is desirable as an alignment layer. The rubbing treatment is performed by rubbing the surface of the polymer layer in a direction several times with a paper or a cloth. In general, rod-like liquid-crystalline molecules in contact with a surface of an alignment layer are aligned in a direction depending on the rubbing direction of the alignment layer. Thus, it is possible to control the alignment direction of the rod-like liquid-crystalline molecules by adjusting the rubbing direction of the alignment layer. When homogeneous alignment layers, which are capable of aligning liquid-crystalline molecules in a homogeneous alignment state, are employed in the present invention for the first and second optically anisotropic layers, preferably, one of them has a rubbing axis inclined +30 degrees relative to the longitudinal direction and the other has a rubbing axis inclined −30 degrees relative to the longitudinal direction.

Materials for preparing the alignment layer are not specifically limited and may be selected depending on desired liquid-crystal alignment (especially a mean tilt angle). In order to align the liquid-crystalline molecules homogeneously, a polymer used in preparing an alignment layer is desirably selected so as not to lower the surface energy of the alignment layer. Specific examples of the polymers are described in various literatures relating to liquid-crystal cells or optical compensation sheets. For improving adhesion between the liquid-crystalline compound and the transparent substrate, the alignment layer is desirably formed of a polymer having a polymerizable group. The polymerizable group may be introduced to the polymer as a portion in a side chain of a repeating unit constituting the polymer or as a cyclic substituent group of the polymer. The polymers capable of forming chemical bonds with liquid-crystalline molecules at the interface between the alignment layer and the optically anisotropic layer are desirably used, and alignment layers formed of such polymers are described in JPA No. 1997-152509.

The thickness of the alignment layer is preferably 0.01 to 5 micro meters, and more preferably 0.05 to 1 micro meters.

For preparing a first or second optically anisotropic layer, the alignment layer may be formed on a temporary substrate and an optically anisotropic layer may be formed by aligning the liquid-crystalline compound on the alignment layer and then transferred onto a transparent substrate such as a plastic film. The liquid-crystalline compound can maintain an alignment without any alignment layer after being fixed in the alignment.

[Substrate]

The substrate which can be employed in the present invention is transparent desirably. In particular, the substrate preferably has a transmittance of 80% or more. The substrate with low wave length dispersion is used desirably. In particular, the substrate has an Re400/Re700 ratio of less than 1.2 desirably. The substrate has a small optical anisotropy desirably. In particular, the substrate desirably has an in-plane retardation (Re) of 20 nm or less, and more preferably 10 nm or less. When a long substrate has the form of a roll is used, preferably, the first and second layers are deposited prepared on the substrate in the form of a roll, thereby forming a multilayer roll, and then the multilayer roll is cut into a desirable size.

Materials for the substrate include, but not specifically limited to, glass plates or polymer films, among which polymer films are preferred to obtain light-weight thin-layer products. Examples of polymers include cellulose esters, polycarbonates, polysulfones, polyether sulfones, polyacrylates and polymethacrylates, preferably cellulose esters, more preferably acetyl cellulose, most preferably triacetyl cellulose. The polymer films are preferably formed by solvent casting. The thickness of the transparent substrate is preferably 20 to 500 micro meters, more preferably 50 to 200 micro meters. The transparent substrate may be subjected to a surface treatment (e.g., glow discharge treatment, corona discharge treatment, UV treatment, flame treatment, saponification treatment) to improve adhesion between the transparent substrate and the overlying layer (an adhesive layer, orthogonal alignment layer or optically anisotropic layer). An adhesive layer (undercoat layer) may be provided on the transparent substrate.

[Circular Polarizer Plate]

The retarder of the present invention is most advantageous when it is applied to a quarter wave plate used for reflective-type liquid crystal display devices, write pickups for optical disks, or anti-reflective films. The quarter wave plate is generally configured as a circular polarizer plate as being combined with a linear polarizer film. Therefore the quarter wave plate configured as a circular polarizer plate as being combined with a linear polarizer film can readily be incorporated into devices such as having functions of reflective-type, liquid-crystal display devices. Known types of the polarizer film include iodine-containing polarizer film, dye-containing polarizer film using dichroic dye, and poly-ene containing polarizer film. The iodine-containing polarizer film and dye-containing polarizer film are generally manufactured using poly(vinyl alcohol)-base films.

The present invention employs a linear polarizer film having a transparent axis inclined substantially at +45 degrees or −45 degrees relative to the longitudinal direction of the film (simply referred to as “45° linear polarizer film”). Since usually a linear polarizer film composed of a stretched film has a transparent axis substantially parallel to a stretching direction, a 45° linear polarizer film can be prepared by stretching a film in a direction inclined at 45 degrees relative to the longitudinal direction of the film, with conditions and machines described in JPA No. 2002-86554.

According to the present invention, the retarder can be functioned as the protective film on one side of the linear polarizer film. For the case where the circular polarizer plate is fabricated using the 45° polarizer film, right and left circular polarizer plates can readily be fabricated in a selective manner by changing the way of stacking.

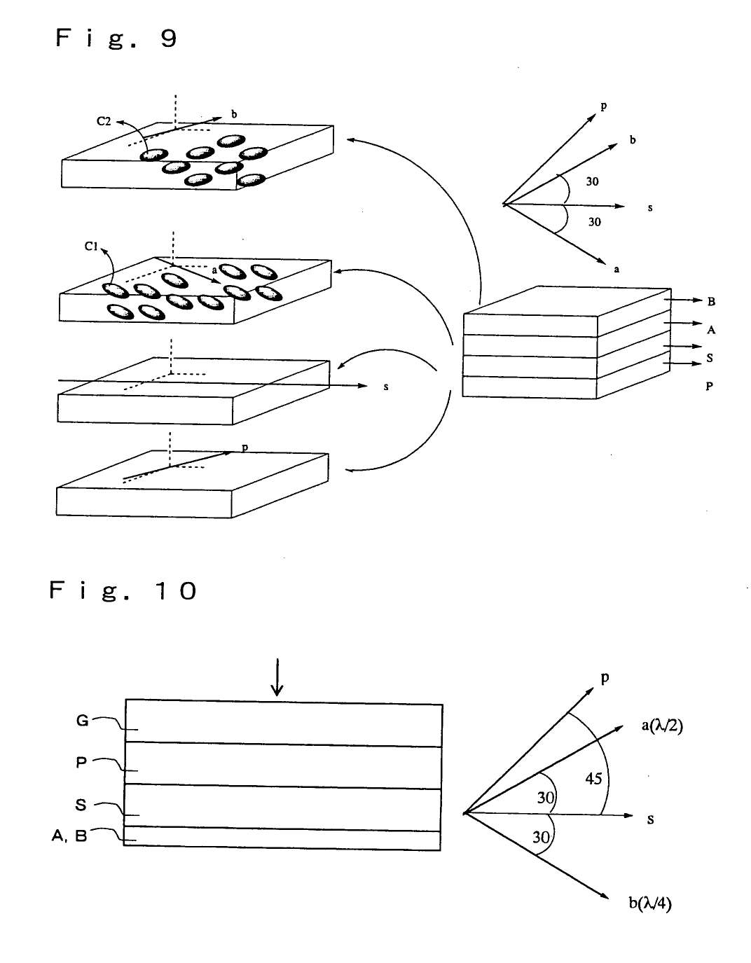

FIG. 10 shows a conceptual drawing of one embodiment of the circular polarizer plate of the present invention.

The circular polarizer plate shown in FIG. 10 is configured so as to stack a 45° polarizer film P and a protective film G on the retarder of the present invention. The retarder comprises an optically anisotropic layers A and B (shown as a single layer in FIG. 10), and a transparent substrate S. The retarder is stacked with the 45° polarizer film P, so that the surface opposite to that having the optically anisotropic layers A and B formed thereon is towards the 45° polarizer film P. In this configuration, the retarder also functions as a protective film for the 45° polarizer film P. FIG. 10 also shows interrelations among the longitudinal direction s of the transparent substrate S, the slow axes a and b of the optically anisotropic layers A and B, and the transparent axis p of the 45° polarizer film P.

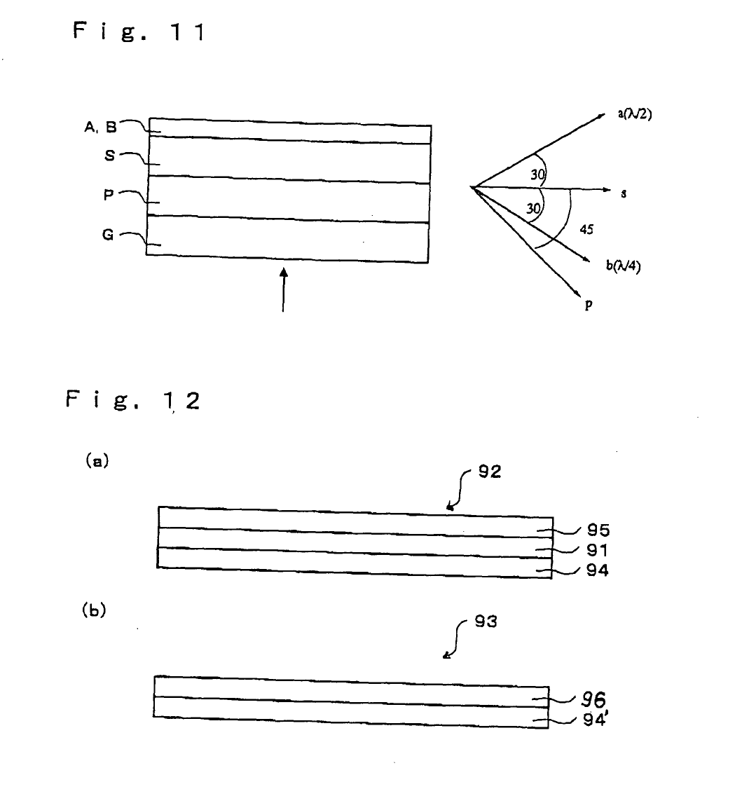

In incorporation of the circular polarizer plate shown in FIG. 10 into display devices, the protective film P side is directed to the display surface side (an arrow in the drawing indicates the direction of viewing). Linear light is changed to a right polarized light by passing through the configuration shown in FIG. 10. Light comes from the direction indicated by the arrow in FIG. 11 sequentially passes through the polarizer film P and optically anisotropic layers A and B, and goes out as a right circular polarized light.

Another exemplary constitution of the circular polarizer plate of the present invention is shown in FIG. 11. The circular polarizer plate shown in FIG. 11 has a configuration in which positions of the protective film G and retarder previously shown in FIG. 10 were exchanged, where protective film G, 45° polarizer film P, transparent substrate S and optically anisotropic layers A and B are stacked in this order. Linear light is changed to left polarized light by passing through the configured circular polarizer plate shown in FIG. 11.

As is obvious from the above, a right circular polarized light and left circular polarized light can selectively be obtained only by changing the top and bottom of the stacking when the protective film G and retarder are bonded to the 45° polarizer film P.

For the case where the protective film is used besides the transparent substrate, the protective film is preferably composed of a cellulose ester film having a high optical isotropy, where triacetyl cellulose film is particularly preferable.

In the present specification, the term of “broadband quarter wave plate” is used for any quarter wave plates having values of {(retardation value/(wavelength)} measured at 450 nm, 550 nm and 650 nm fall within a range from 0.2 to 0.3. The value of retardation value/wavelength is preferably within a range from 0.21 to 0.29, more preferably 0.22 to 0.28, still more preferably 0.23 to 0.27, and most preferably from 0.24 to 0.26.

### EXAMPLES

The following paragraphs will further detail the present invention referring to specific examples. Any materials, reagents, ratio of use and operations may properly be modified without departing form the spirit of the present invention. It is therefore be understood that the scope of the present invention is by no means limited by the Examples below.

### Example 1

An optically-isotropic triacetyl cellulose film in the form of 100 micro meters in thickness, 150 mm in width and 20 m in length was used as a transparent substrate. A coating solution containing a polymer of the structural formula shown below was continuously applied to a surface of the transparent substrate and dried to form a layer having a thickness of 0.5 micro meters. Then, a rubbing treatment was continuously performed to a surface of the layer in a direction at +30 degrees relative to the longitudinal direction of the transparent substrate, to form an alignment layer capable of aligning rod-like liquid-crystalline molecules in a parallel direction relative to the rubbing axis.

Polymer for an alignment layer

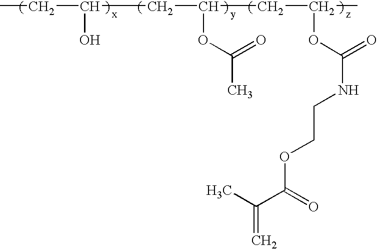

X:y:z(molar ratio)=97:2:1

A coating solution of the composition below was continuously applied to a surface of the alignment layer with a bar coater, dried, heated (matured in alignment) and further irradiated with UV rays to form an optically anisotropic layer (A) having a thickness of 2.0 micro meters. The optically anisotropic layer (A) had a slow axis in a direction at +30 degrees relative to the longitudinal direction of the transparent substrate. The retardation value at 550 nm was 265 nm.

Composition of the coating solution for the optically anisotropic layer (A)

Rod-like liquid-crystalline compound bellow 14.5 wt %

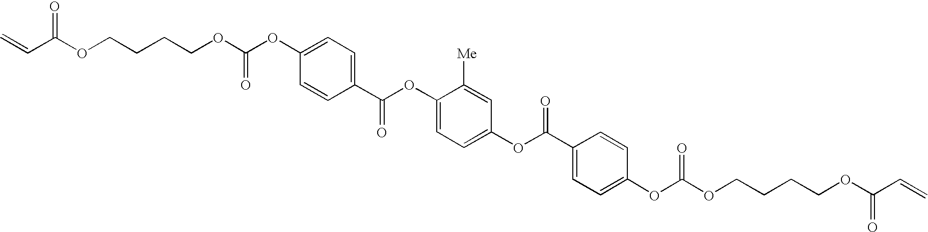

| | |
|---|---|
| Sensitizer (1) below | 0.15 wt % |

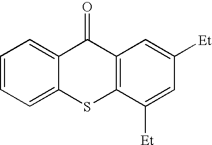

| | |
|---|---|
| Photo-polymerization initiator (1) below | 0.29 wt % |

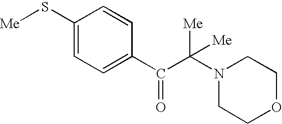

| | |
|---|---|
| Additive (1) (Compound NO. (V)-20) below | 0.15 wt % |

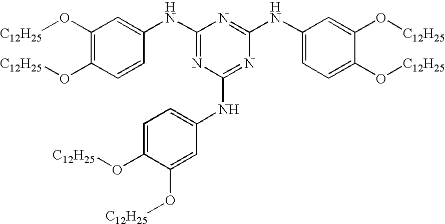

| | |
|---|---|
| Methyl ethyl ketone | 84.91 wt % |

The above-mentioned coating solution for an alignment layer was applied to a surface of the layer (A) to form a layer on the layer (A). A rubbing treatment was continuously performed to a surface of the layer in a direction at −60 degrees relative to the slow axis of the layer (A) and at −30 degrees relative to longitudinal direction of the transparent substrate, to form an alignment layer.

A coating solution of the composition below was continuously applied to the rubbed surface of the alignment layer with a bar coater, and dried and heated (matured in alignment), and further irradiated with UV rays to form an optically anisotropic layer (B) having a thickness of 1.0 micro meters.

Composition of the coating solution for the optically anisotropic layer (B)

| | |
|---|---|
| The rod-like liquid-crystalline compound (1) | 13.0 wt % |
| The sensitizer (1) | 0.13 wt % |
| The photo-polymerization initiator (1) | 0.39 wt % |
| The additive (1) (Compound No. (V)-20) | 0.13 wt % |
| Methyl ethyl ketone | 86.35 wt % |

### Comparative Example 1

An alignment layer was prepared on a substrate in the same manner as Example 1 except that a rubbing treatment was performed in a direction at +75 degrees relative to the longitudinal direction of the substrate. And an optically anisotropic layer (A) was prepared in the same manner as Example 1. A lot of alignment defects were found in the layer and the slow axis of the alignment area was about +60 degrees relative to the longitudinal direction.

### Comparative Example 2

An optically-isotropic triacetyl cellulose film in the form of 100 micro meters in thickness, 150 mm in width and 20 m in length was used as a transparent substrate. A coating solution containing a polymer of the structural formula shown below was continuously applied to the surface of the transparent substrate and dried to form a layer having a thickness of 0.5 micro meters. Then, a rubbing treatment was continuously performed to a surface of the layer in a direction at −15 degrees relative to the longitudinal direction of the transparent substrate to form an alignment layer capable of aligning rod-like liquid-crystalline molecules in an orthogonal direction relative to the rubbing axis.

Polymer of an alignment layer for aligning molecules in an orthogonal direction relative to a rubbing direction

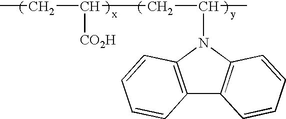

x:y (molar ration)=70:30

An optically anisotropic layer was prepared in the same manner as Example 1. A layer was prepared on the surface of the layer (A) in the same manner as Example 1, and the surface of the layer was continuously rubbed in a direction at +15 degrees relative to the longitudinal direction of the transparent substrate to form an alignment layer. An optically anisotropic layer (B) was prepared on the rubbed surface in the same manner as Example 1.

### Example 2

A polyvinyl alcohol (PVA) film was immersed in an aqueous solution containing 2.0 g/L of iodine and 4.0 g/L of potassium iodide at 25 degrees Celsius for 240 seconds and subsequently in an aqueous solution of 10 g/L boric acid at 25 degrees Celsius for 60 seconds. The PVA film was introduced into a tenter stretcher same as that described in FIG. 2 of JPA No.2002-86554 and stretched by 5.3 times. While the tenter was bent far from the stretching direction in the same manner as shown FIG. 2 of JPA No.2002-86554 and the tenter width was kept constant, the PVA film was dried in an atmosphere of 80 degrees Celsius, contracted and put out of the tenter. The PVA film contained 31% of moisture before stretching and 1.5% after drying respectively.

The difference in traveling speed between the left and an right tenter clips was less than 0.05%; and an angle between the center line of the PVA film to be introduced into the stretcher and the center line of the PVA film to be sent to a next step was 46°. The used tenter stretcher had |L1-L2| of 0.7 m and W of 0.7 m, that is, satisfying a relation of |L1-L2|=W, (|L1-L2| and W were identically defined with those described in FIG. 2 of JPA No.2002-86554). “Ax-Cx”, which was a substantial stretching direction at the exit of the tenter stretcher and identically defined with that described in FIG. 2 of JPA No.2002-86554, is inclined at 45° relative to the center line (shown by 22 in FIG. 2 of JPA No.2002-86554) of the PVA film to be sent to a next step. Neither winkle nor deformation of the PVA film was found at the exit of the tenter stretcher.

A commercially available cellulose acetate film (“FUJITAC” whose retardation was 3.0 nm, FUJI PHOTO FILM Co., LTD.) was subjected to saponification treatment, and then the film was laminated on the surface of the obtained stretched PVA film with an aqueous solution of 3% PVA (PVA-117H, KRARAY CO., LTD.) as an adhesive, and dried at 80 degrees Celsius. Then, a linear polarizer plate having a working width of 650 mm was obtained.

The obtained linear polarizer plate had an absorption axis in a direction inclined at 45 degrees relative to the longitudinal direction. The polarizer plate had a transmittance of 43.7% and a polarization degree of 99.97%. The polarizer plate was cut into a piece having a dimension of 310 mm×233 mm in the same manner as that described in FIG. 8 of JPA No. 2002-86554. Thus, the polarizer plate having the dimension and an absorption axis in a direction inclined at 45 degrees relative to the side at an area efficiency of 91.5%.

Next, as shown in FIG. 12 (a), the retarder 94 which was prepared in the Example 1 was laminated on one side of the obtained iodine-based linear polarizer film 91 and an antidazzle antireflective film 95 subjected to a saponification treatment was laminated to another side such that the longitudinal directions of the linear polarizer film 91 and the retarder 95 were identical. Thus, circular polarizer 92 was prepared.

### Comparative Example 3

A circular polarizer 93 shown in FIG. 12(b) was prepared by laminating the retarder prepared in the Comparative Example 2 on one side of an antidazzle polarizer 96 (“HEG1425DUHCARS” manufactured by NITTO DENKO CORPORATION), such that the longitudinal directions of the polarizer 96 and the retarder were identical.

[Evaluation]

Each of thus-obtained circular polarizer plates 92 and 93 was irradiated with light (450 nm, 550 nm and 650 nm) from the antidazzle antireflective film 95 side, and phase difference (retardation value: Re) of the transmitted light was measured at the each wave lengths respectively. The retarders used in preparation the each circular polarizer were observed under a polarizing microscope, and the numbers of alignment defects in the retarders were counted. The results are shown bellow.

TABLE 1

| Cir- | | | | | |
|---|---|---|---|---|---|
| cular | | | | | |
| polar- | | | | | Number |
| izer | | | | | of |
| No. | Retareder | Re (450 nm) | Re (550 nm) | Re (650 nm) | defects |
| 92 | Example 1 | 112 nm | 135 nm | 143 nm | 2 |
| 93 | Comparative | 112 nm | 136 nm | 142 nm | 13 |
| | Example 2 | | | | |

| | | | | |
|---|---|---|---|---|
| Ideal value | 112.5 nm | 137.5 nm | 157.5 nm | 0 |

As indicated in the Table 1, according to the present invention, it is possible to prepare circular polarizers less in defects and excellent in stability.

### Example 3

### Preparation of Reflective-Type, Liquid-Crystal Display Device

A polarizer plate and a retarder were removed from a commercial reflective-type, liquid-crystal display device (“Color Zaurus MI−310”, product of SHARP Corporation, Japan), and the circular polarizer plate 92 and 93 were respectively attached instead. Thus, reflective-Type, liquid-Crystal display devices were obtained.

(Evaluation)

Evaluated by visual observation respectively, it was found that all of these circular polarizer plates 92 and 93 resulted in neutral gray display in either of white display, black display and half tone display, without developing color.

Next, contrast ratio based on reflective luminance was measured using a viewing angle measuring instrument (EZcontrast160D, product of Eldim SA, France). The contrast ratio measured at the front face through the circular polarizer plate 92 comprising the retarder obtained by Examples 1 was found 10, and the contrast ratio measured at the front face through the circular polarizer plate 93 comprising the retarder obtained by Comparative Examples 2 was found 5.

According to the present invention, it is made possible to provide retarders capable of functioning in a broad band, that is, in the visible light wave length region, of contributing to thinning, and of being prepared stably and easily. The present invention can also provide circular polarizer capable of functioning in a broad band, in the visible light wave length region, of contributing to thinning, and of being prepared stably and easily.

Having described our invention as related to the present embodiments, it is our intention that the invention not be limited by any of the details of the description, unless otherwise specified, but rather be construed broadly within its spirit and scope as set out in the accompanying claims.

What is claimed is:

1. A retarder comprising:
a substrate having a longitudinal direction,
a first optically anisotropic layer formed of a composition comprising a rod-like liquid-crystalline compound, in which the rod-like molecules are aligned homogeneously, and substantially generating a phase difference of π at 550 nm, and
a second optically anisotropic layer formed of a composition comprising a rod-like liquid-crystalline compound, in which the rod-like molecules are aligned homogeneously, and substantially generating a phase difference of π/2 at 550 nm;
wherein an in-plane slow axis of the first optically anisotropic layer and the longitudinal direction of the substrate cross substantially at +30 degrees, an in-plane slow axis of the second optically anisotropic layer and the longitudinal direction of the substrate cross substantially at −30 degrees, and the in-plane slow axis of the second optically anisotropic layer and the in-plane slow axis of the first optically anisotropic layer cross substantially at 60 degrees.

2. The retarder of claim 1, wherein a rubbing axis of an alignment layer for predetermining an orientation angle of the rod-like molecules in the first optically anisotropic layer and the longitudinal direction of the substrate cross substantially at +30 degrees, and a rubbing axis of an alignment layer for predetermining an orientation angle of the rod-like molecules in the second optically anisotropic layer and the longitudinal direction of the substrate cross substantially at −30 degrees.

3. The retader of claim 1, wherein at least one of the first and second optically anisotropic layers is formed of a composition comprising a rod-like liquid-crystalline compound denoted by Formula (I) bellow:
Q¹—L¹—Cy¹—L²—(Cy²—L³)ₙ—Cy³—L⁴—Q² Formula (I)
where Q¹ and Q²respectively denote a polymerizable group; L¹ and L⁴ respectively denote a divalent linking group, L² and L³ respectively denote a single bond or divalent linking group; Cy¹, Cy², and Cy³ respectively denote a divalent cyclic group; and n is 0, 1 or 2.

4. The retader of claim 1, wherein at least one of the first and second optically anisotropic layers is formed of a composition comprising a compound denoted by Formula (V) bellow:
(Hb—L⁵²—)ₙB⁵¹ Formula (V)
where Hb represents a C6-40 aliphatic group, or oligosiloxanoxy group having a C6-40 aliphatic group; L⁵² is a single bond or divalent linking group; B⁵¹ is an n-valent group showing an excluded volume effect and comprising at least three rings and n is an integer from 2 to 12.

5. The retader of claim 4, wherein B⁵¹ is an n-valent group denoted by Formula (V-a);
(−Cy⁵¹—L⁵³—)ₙ Cy⁵² Formula (V-a)
where Cy⁵¹ is a divalent cyclic group; L⁵³ is a divalent linking group selected from the group consisting of a single bond, -alkylene-, -alkenylene-, -alkynylene-, —O—, —S—, —CO—, —NR—, —SO₂— and any combinations thereof; Cy⁵² is an n-valent cyclic group; and n is an integer from 2 to 12.

6. A process for preparing a retarder comprising:
(i) a step of preparing a layer on or above a surface of a substrate having a longitudinal direction and rubbing a surface of the layer in a direction at +30 degrees relative to the longitudinal direction of the substrate, to prepare a first alignment layer capable of aligning rod-like liquid-crystalline molecules in a direction parallel to a rubbing axis,
(ii) a step of applying a composition comprising a rod-like liquid-crystalline compound to the rubbed surface of the first alignment layer and aligning rod-like molecules homogenously in a direction parallel to the rubbing axis of the first alignment layer, to prepare a first optically anisotropic layer generating substantially a phase difference of π at 550 nm,
(iii-1) a step of preparing a layer on or above the surface of the substrate and rubbing a surface of the layer in a direction at −30 degrees relative to the longitudinal direction of the substrate, namely, in a direction crossing the rubbing axis of the first alignment layer at 60 degrees, to prepare a second alignment layer capable of aligning rod-like liquid-crystalline molecules in a direction parallel to a rubbing axis, or
(iii-2) a step of preparing a layer on or above a rear surface of the substrate and rubbing a surface of the layer in a direction at +30 degrees relative to the longitudinal direction of the substrate, namely, in a direction crossing the rubbing axis of the first alignment layer at 60 degrees, to prepare a second alignment layer capable of aligning rod-like liquid-crystalline molecules in a direction parallel to a rubbing axis, and
(iv) a step of applying a composition comprising a rod-like liquid-crystalline compound to the rubbed surface of the second alignment layer and aligning rod-like molecules homogenously in a direction parallel to the rubbing axis of the second alignment layer, to prepare a second optically anisotropic layer generating substantially a phase difference of π/2 at 550 nm.

7. The process of claim 6, wherein at least one of the rod-like liquid-crystalline compounds used in the first and second optically anisotropic layers is denoted by Formula (I) bellow:
Q¹—L¹—Cy¹—L²—(Cy²—L³)ₙ—Cy³—L⁴—Q² Formula (I)
where Q¹ and Q² respectively denote a polymerizable group; L¹ and L⁴ respectively denote a divalent linking group, L² and L³ respectively denote a single bond or divalent linking group; Cy¹, Cy², and Cy³ respectively denote a divalent cyclic group; and n is 0, 1 or 2.

8. The process of claim 6, wherein at least one of the compositions for the first and second optically anisotropic layers comprises a compound denoted by Formula (V) bellow:
(Hb—L⁵²—)ₙB⁵¹ Formula (V)
where Hb represents a C6-40 aliphatic group, or oligosiloxanoxy group having a C6-40 aliphatic group; L⁵² is a single bond or divalent linking group; B⁵¹ is an n-valent group showing an excluded volume effect and comprising at least three rings and n is an integer from 2 to 12.

9. The process of claim 6, wherein B⁵¹ is an n-valent group denoted by Formula (V-a);
(—Cy⁵¹—L⁵³—)ₙ Cy⁵² Formula (V-a)
where Cy⁵¹ is a divalent cyclic group; L⁵³ is a divalent linking group selected from the group consisting of a single bond, -alkylene-, -alkenylene-, -alkynylene-, —O—, —S—, —CO—, —NR—, —SO₂— and any combinations thereof; Cy⁵² is an n-valent cyclic group; and n is an integer from 2 to 12.

10. A circular polarizer comprising:
a linear polarizer film having a transparent axis substantially inclined at +45 degrees or −45 degrees relative to a longitudinal direction thereof,
a substrate having a longitudinal direction,
a first optically anisotropic layer formed of a composition comprising a rod-like liquid-crystalline compound, in which the rod-like molecules are aligned homogeneously, and substantially generating a phase difference of π at 550 nm, and
a second optically anisotropic layer formed of a composition comprising a rod-like liquid-crystalline compound, in which the rod-like molecules are aligned homogeneously, and substantially generating a phase difference of π/2 at 550 nm;
wherein an in-plane slow axis of the first optically anisotropic layer and the longitudinal direction of the substrate cross substantially at +30 degrees, an in-plane slow axis of the second optically anisotropic layer and the longitudinal direction of the substrate cross substantially at −30 degrees, and the in-plane slow axis of the second optically anisotropic layer and the in-plane slow axis of the first optically anisotropic layer cross substantially at 60 degrees.

11. The circular polarizer of claim 10, wherein a rubbing axis of an alignment layer for predetermining an orientation angle of the rod-like molecules in the first optically anisotropic layer and the longitudinal direction of the substrate cross substantially at +30 degrees, and a rubbing axis of an alignment layer for predetermining an orientation angle of the rod-like molecules in the second optically anisotropic layer and the longitudinal direction of the substrate cross substantially at −30 degrees.

12. The circular polarizer of claim 10, wherein at least one of the first and second optically anisotropic layers is formed of a composition comprising a rod-like liquid-crystalline compound denoted by Formula (I) bellow:
Q¹—L¹—Cy¹—L²—(Cy²—L³)ₙ—Cy³—L⁴—Q² Formula (I)
where Q¹ and Q² respectively denote a polymerizable group; L¹ and L⁴ respectively denote a divalent linking group, L² and L³ respectively denote a single bond or divalent linking group; Cy¹, Cy², and Cy³ respectively denote a divalent cyclic group; and n is 0, 1 or 2.

13. The circular polarizer of claim 10, wherein at least one of the first and second optically anisotropic layers is formed of a composition comprising a compound denoted by Formula (V) bellow:
(Hb—L⁵²—)ₙB⁵¹ Formula (V)
where Hb represents a C6-40 aliphatic group, or oligosiloxanoxy group having a C6-40 aliphatic group; L⁵² is a single bond or divalent linking group; B⁵¹ is an n-valent group showing an excluded volume effect and comprising at least three rings and n is an integer from 2 to 12.

14. The circular polarizer of claim 13, wherein B⁵¹ is an n-valent group denoted by Formula (V-a);
(—Cy⁵¹—L⁵³—)ₙ Cy⁵² Formula (V-a)
where Cy⁵¹ is a divalent cyclic group; L⁵³ is a divalent linking group selected from the group consisting of a single bond, -alkylene-, -alkenylene-, -alkynylene-, —O—, —S—, —CO—, —NR—, —SO₂— and any combinations thereof; Cy⁵² is an n-valent cyclic group; and n is an integer from 2 to 12.

15. A process for preparing a circular polarizer comprising:
(i) a step of preparing a layer on or above a surface of a substrate having a longitudinal direction and rubbing a surface of the layer in a direction at +30 degrees relative to the longitudinal direction of the substrate, to prepare a first alignment layer capable of aligning rod-like liquid-crystalline molecules in a direction parallel to a rubbing axis,
(ii) a step of applying a composition comprising a rod-like liquid-crystalline compound to the rubbed surface of the first alignment layer and aligning rod-like molecules homogenously in a direction parallel to the rubbing axis of the first alignment layer, to prepare a first optically anisotropic layer generating substantially a phase difference of π at 550 nm,
(iii-1) a step of preparing a layer on or above the surface of the substrate and rubbing a surface of the layer in a direction at −30 degrees relative to the longitudinal direction of the substrate, namely, in a direction crossing the rubbing axis of the first alignment layer at 60 degrees, to prepare a second alignment layer capable of aligning rod-like liquid-crystalline molecules in a direction parallel to a rubbing axis, or
(iii-2) a step of preparing a layer on or above a rear surface of the substrate and rubbing a surface of the layer in a direction at +30 degrees relative to the longitudinal direction of the substrate, namely, in a direction crossing the rubbing axis of the first alignment layer at 60 degrees, to prepare a second alignment layer capable of aligning rod-like liquid-crystalline molecules in a direction parallel to a rubbing axis,
(iv) a step of applying a composition comprising a rod-like liquid-crystalline compound to the rubbed surface of the second alignment layer and aligning rod-like molecules homogenously in a direction parallel to the rubbing axis of the second alignment layer, to prepare a second optically anisotropic layer generating substantially a phase difference of π/2 at 550 nm, and
(v) a step of laminating a linear polarizer film, having a transparent axis substantially inclined at +45 degrees or −45 degrees relative to a longitudinal direction thereof, on or above the surface or the rear surface of the substrate, so that the longitudinal directions of the linear polarizer film and of the substrate are identical.

16. The process of claim 15, wherein the first and second optically anisotropic layers are prepared on or above the surface of the substrate and the linear polarizer film is laminated on or above the surface of the substrate.

17. The process of claim 15, wherein the first and second optically anisotropic layers are prepared on or above the surface of the substrate and the linear polarizer film is laminated on or above the rear surface of the substrate.

18. The process of claim 15, wherein at least one of the rod-like liquid-crystalline compounds used in the first and second optically anisotropic layers is denoted by Formula (I) bellow:
Q¹—L¹—Cy¹—L²—(Cy²—L³)ₙ—Cy³—L⁴—Q² Formula (I)
where Q¹ and Q² respectively denote a polymerizable group; L¹ and L⁴ respectively denote a divalent linking group, L² and L³ respectively denote a single bond or divalent linking group; Cy¹, Cy², and Cy³ respectively denote a divalent cyclic group; and n is 0, 1 or 2.

19. The process of claim 15, wherein at least one of the composition used for the first and second optically anisotropic layers comprises a compound denoted by Formula (V) bellow:
(Hb—L⁵²—)ₙB⁵¹ Formula (V)
where Hb represents a C6-40 aliphatic group, or oligosiloxanoxy group having a C6-40 aliphatic group; L⁵² is a single bond or divalent linking group; B⁵¹ is an n-valent group showing an excluded volume effect and comprising at least three rings and n is an integer from 2 to 12.

20. The process of claim 19, wherein B⁵¹ is an n-valent group denoted by Formula (V-a);
(—Cy⁵¹—L⁵³—)ₙ Cy⁵² Formula (V-a)
where Cy⁵¹ is a divalent cyclic group; L⁵³ is a divalent linking group selected from the group consisting of a single bond, -alkylene-, -alkenylene-, -alkynylene-, —O—, —S—, —CO—, —NR—, —SO₂— and any combinations thereof; Cy⁵² is an n-valent cyclic group; and n is an integer from 2 to 12.
